(19) United States
(12) Patent Application Publication
(10) Pub. No.: US 2020/0333485 A1
(43) Pub. Date: Oct. 22, 2020

(54) RANDOMIZING SWEEPS IN A MARINE SURVEY

(71) Applicant: PGS GEOPHYSICAL AS, Oslo (NO)

(72) Inventors: Stian Hegna, Hovik (NO); Okwudili Orji, Drammen (NO); Mattias Oscarsson-Nagel, Oslo (NO)

(73) Assignee: PGS GEOPHYSICAL AS, Oslo (NO)

(21) Appl. No.: 16/845,587

(22) Filed: Apr. 10, 2020

Related U.S. Application Data
(60) Provisional application No. 62/834,430, filed on Apr. 16, 2019.

(51) Int. Cl. G01V 1/00; G01V 1/38

(52) U.S. Cl. CPC G01V 1/005; G01V 1/006; G01V 1/3808; G01V 1/3861; G01V 1/3843

(57) ABSTRACT

Processes and systems described herein are directed to performing marine surveys with a moving vibrational source that emits a continuous source wavefield into a body of water above a subterranean formation. The continuous source wavefield is formed from multiple sweeps in which each sweep is emitted from the moving vibrational source into the body of water with a randomized phase and/or with a randomized sweep duration. Reflections from the subterranean formation are continuously recorded in seismic data as the moving vibrational source travels above the subterranean formation. Processes and systems include iteratively deconvolving the source wavefield from the continuously recorded seismic data to obtain an earth response in the common receiver domain with little to no harmful effects from spatial aliasing and residual crosstalk noise. The earth response may be processed to generate an image of the subterranean formation.

### CROSS-REFERENCE TO RELATED APPLICATION

This application claims the benefit of Provisional Application 62/834,430, filed Apr. 16, 2019, which application is hereby incorporated by reference as if entirely set forth herein.

### BACKGROUND

Marine seismology companies invest heavily in the development of marine seismic surveying equipment and seismic data processing techniques in order to obtain accurate, high-resolution images of subterranean formations located beneath a body of water. Such images may be used, for example, to determine the structure of the subterranean formations, to discover petroleum reservoirs, and to monitor petroleum reservoirs during production. A typical marine seismic survey is performed with one or more survey vessels that tow a seismic source and many streamers through the body of water. The survey vessel contains seismic acquisition equipment, such as navigation control, seismic source control, seismic receiver control, and recording equipment. A seismic source control controls activation of the one or more seismic sources at selected times or locations. A seismic source may be an impulsive source comprised of an array of air guns that are activated to produce impulses of acoustic energy. Alternatively, a seismic source may be a marine vibrator that emits acoustic energy over a longer time period. The acoustic energy generated by a seismic source spreads out in all directions. A portion of the acoustic energy travels down through the water and into a subterranean formation to propagate as sound waves within the subterranean formation. At each interface between different types of liquid, rock and sediment, a portion of the sound wave is refracted, a portion is transmitted, and another portion is reflected into the body of water to propagate as a reflected wavefield toward the water surface. The streamers are elongated spaced apart cable-like structures towed behind a survey vessel in the direction the survey vessel is traveling and are typically arranged substantially parallel to one another. Each streamer contains many seismic receivers or sensors that detect pressure and/or particle motion wavefields of the sound waves. The streamers collectively form a seismic data acquisition surface that records wavefields as seismic data in the recording equipment. The recorded pressure and/or particle motion wavefields are processed to generate images of the subterranean formation, enabling geoscientist to identify potential hydrocarbon reservoirs that may be suitable for oil and gas extraction and to monitor hydrocarbon reservoirs under production.

### DESCRIPTION OF THE DRAWINGS

FIGS. 1A-1B show side-elevation and top views of an example marine seismic data acquisition system.

FIG. 2 shows an isometric view of an example vibrational source.

FIG. 3A shows a plot of example increasing frequencies of sweeps.

FIG. 3B shows a plot of an example sweep signature of a sweep produced by a marine vibrator.

FIG. 3C shows a plot of an example frequency spectrum of a sweep.

FIG. 4 shows a plot of example sweep signatures of sweeps emitted from a marine vibrator with different phases.

FIG. 5A shows a plot of an example of a sweep signature of a sweep emitted from a marine vibrator with a randomized sweep duration.

FIG. 5B shows a plot of example of frequencies of sweeps emitted from a marine vibrator over a minimum sweep duration, a maximum sweep duration sweep, and a randomized sweep duration.

FIG. 6A shows a plot of example sweep signatures of three successive sweeps emitted from a marine vibrator with randomized phases and in randomized sweep durations.

FIG. 6B shows plots of example frequencies of the three sweeps represented by sweep signatures in FIG. 6A.

FIG. 7A shows a plot of example sweep signatures of five successive non-overlapping sweeps emitted from four marine vibrators with randomized phases and with randomized sweep durations.

FIG. 7B shows a plot of example frequencies of the Five sweeps represented by sweep signatures in FIG. 7A.

FIG. 7C shows a plot of example sweep signatures of overlapping sweeps emitted continuously from four marine vibrators with randomized phases and with randomized sweep durations.

FIG. 7D shows a plot of example frequencies of four overlapping sweeps represented by sweep signatures in FIG. 7C.

FIG. 8 shows a side-elevation view of a marine seismic data acquisition system with a magnified view of a receiver.

FIGS. 9A-9C show example ray paths of different ways acoustic energy emitted from a vibrational source reverberates between a free surface and reflectors within a subterranean formation before reaching a receiver.

FIG. 10 shows an example of continuously recording seismic data while a survey vessel travels along a sail line and emits sweeps from a vibrational source.

FIG. 11 shows an example matrix of continuous recorded seismic data with traces at stationary-receiver locations.

FIG. 12 shows a relationship between an emission angle and a propagation direction of a sweep emitted from a vibrational source.

FIG. 13 shows an example signal cone for an earth response trace in the wavenumber-frequency domain.

FIG. 14 is a flow diagram of a process for generating an image of a subterranean formation from continuously recorded seismic data obtained in a marine seismic survey.

FIG. 15 is a flow diagram illustrating an example implementation of the “deconvolve the total source wavefield from the upgoing pressure wavefield data to obtain an earth response to the source wavefield” procedure performed in a step of FIG. 14.

FIG. 16 shows an example computer system that may be used to execute an efficient process for generating an image of subterranean formation according to methods described herein.

FIGS. 17-20C show plots of simulation results.

### DETAILED DESCRIPTION

In recent years, interest in replacing impulsive sources in marine surveys with marine vibrators has increased. A typical impulsive source comprises air guns that when activated rapidly release compressed gasses into the surrounding water, producing a burst of acoustic energy in about 30 milliseconds (i.e., about 0.03 seconds). An impulsive source signature is characterized by a pulse with an acoustic amplitude rise time of only a few milliseconds between the ambient background noise level and the maximum acoustic amplitude. By contrast, a vibrational source may comprise a single marine vibrator or an array of marine vibrators. Each marine vibrator emits acoustic energy in the form of an oscillating pressure wavefield called a “sweep.” A sweep may be characterized by a sinusoidal amplitude that monotonically increases at the beginning of the sweep, levels off for a period of time, then decreases to zero by the end of the sweep and has a frequency of oscillation that increases for the duration of the sweep. Vibrational sources have potential advantages over impulsive sources. For example, vibrational sources produce acoustic energy with lower sound pressure levels than impulsive sources, which may have less of an environmental impact on marine life than impulsive sources.

For marine surveys performed with a moving marine vibrator, seismic data is typically recorded in fixed length sweep intervals. For each sweep interval, a marine vibrator emits a sweep with the same fixed sweep duration followed by a fixed time delay. However, when traces of recorded seismic data are sorted into the common receiver domain, the common receiver gathers are spatially aliased for higher sweep frequencies. For source wavefields comprising sweeps generated with regular spacing and in fixed length sweep intervals with fixed sweep durations, the minimum sweep frequency beyond which spatial aliasing starts to occur, fₐ, is related to the velocity of sound in water, c (e.g., c=1500 m/s), survey vessel speed, vᵥₛ, and duration of the sweep interval, Tₛᵢ, by

$${f}_{a} = \frac{c}{2 {T}_{si} {v}_{vs}}$$

Consider, for example, a marine survey performed with a survey vessel traveling at 2.5 m/s while towing a vibrational source with seismic data recorded in 10 s sweep intervals. Suppose the vibrational source emits each sweep with a 5 s sweep duration in the first half of each sweep interval and each sweep is emitted over a sweep frequency range of about 2 Hz to about 100 Hz. As a result, the source locations are spaced apart by 25 m and traces of common receiver gathers are spaced apart by 25 m. However, spatial aliasing begins to occur in the common receiver gathers for sweep frequencies greater than 30 Hz (i.e., fₐ=(1500 m/s)/(2×10 s×2.5m/s)). In order to reduce the impact of spatial aliasing in the common receiver domain and allow sweeps over the full frequency range up to about 100 Hz, the sweep interval would have to be reduced to about 3 s for a vessel traveling at 2.5 m/s or the vessel speed would have to be slowed to less than 0.75 m/s to maintain a 10 s sweep interval. However, neither adjustment to parameters of a marine survey is a practical approach to addressing the problem of spatial aliasing in the common receiver domain. Sweep intervals of 3 s or shorter are far too short to record an appreciable amount of seismic data and a vessel speed of 0.75 m/s would significantly increase the time and cost of performing a marine survey. In addition, use of a vibrational source with multiple marine vibrators activated simultaneously within fixed sweep intervals creates crosstalk noise contamination of the recorded seismic data.

Processes and systems described herein are directed to performing marine surveys with a moving vibrational source that emits a continuous source wavefield into a body of water above a subterranean formation. The continuous source wavefield is formed from multiple sweeps in which each sweep is emitted from the moving vibrational source into the body of water with a randomized phase and/or with a randomized sweep duration. Reflections from the subterranean formation are continuously recorded in seismic data as the moving vibrational source travels above the subterranean formation. When sweeps are generated with a randomized phase and/or with a randomized sweep duration, there is no specific sweep frequency or wavenumber where spatial aliasing begins for traces sorted into the common receiver domain. In addition, traces of seismic data recorded for sweeps that have been emitted with a randomized phase and/or with a randomized sweep duration from a moving source are less affected by crosstalk noise in the common receiver domain than traces of seismic data recorded with sweeps emitted with fixed sweep durations in fixed length sweep intervals. Processes and systems include iteratively deconvolving the source wavefield from the continuously recorded seismic data to obtain an earth response that is less affected by spatial aliasing and contains little to no crosstalk noise than an earth response obtained by deconvolving a source wavefield formed from sweeps emitted from a moving vibrational source with fixed sweep durations in fixed length sweep intervals. The earth response may be processed to generate an image of the subterranean formation.

### Marine Seismic Surveying Using a Vibrational Source

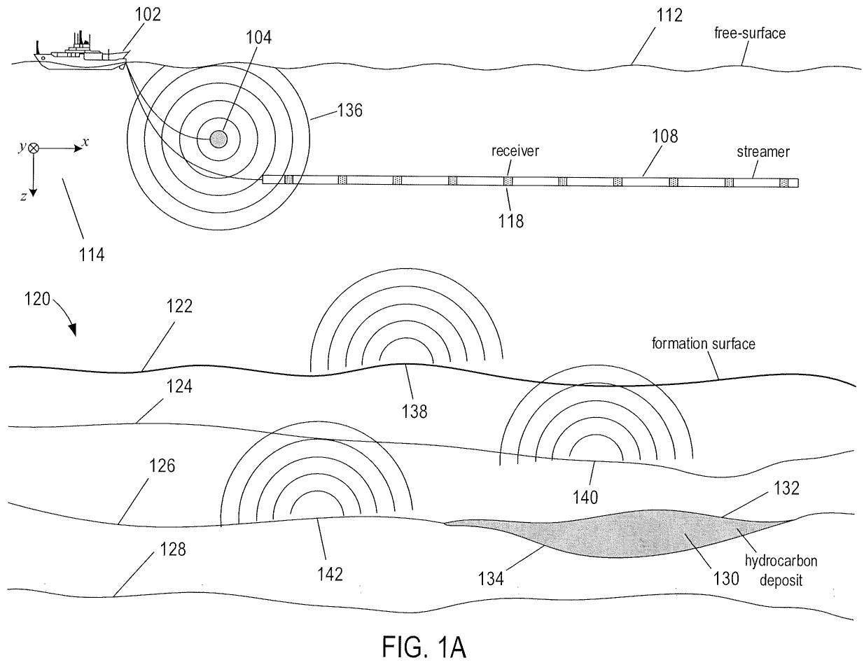

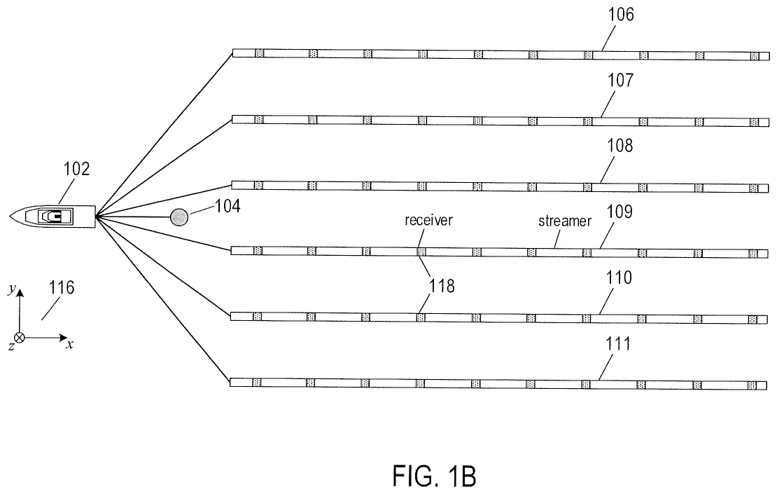

FIGS. 1A-1B show a side-elevation view and a top view, respectively, of an example marine seismic data acquisition system comprising an exploration seismology survey vessel 102 and a vibrational source 104. A seismic data acquisition system is not limited to one source as shown in FIGS. 1A-1B. In practice, the number of sources can range from as few as a single source towed by a survey vessel to multiple sources towed by different survey vessels. The body of water can be, for example, an ocean, a sea, a lake, a river, or any portion thereof. In this example, the survey vessel 102 tows six streamers 106-111 below the free surface of a body of water. Each streamer is attached at one end to the survey vessel 102 via a streamer-data-transmission cable. The illustrated streamers 106-111 form an ideally planar horizontal seismic data acquisition surface of the marine seismic data acquisition system with respect to the free surface 112 of the body of water. However, in practice, the streamers may be smoothly varying due to active sea currents and weather conditions. In other words, although the streamers 106-111 illustrated in FIGS. 1 A and 1B form a planar data acquisition surface, in practice, the towed streamers may undulate because of dynamic conditions of the body of water in which the streamers are submerged. A data acquisition surface is not limited to a planar horizontal orientation with respect to the free surface 112. The data acquisition surface may be angled with respect to the free surface 112 or one or more of the streamers may be towed at different depths. A data acquisition surface is not limited to six streamers as shown in FIG. 1B. In practice, the number of streamers used to form a data acquisition surface can range from as few as one streamer to as many as 20 or more streamers.

FIG. 1 A includes an xz-plane 114, and FIG. 1B includes an xy-plane 116, of the same Cartesian coordinate system having three orthogonal, spatial coordinate axes labeled x, y and z. The coordinate system specifies orientations and coordinate locations within the body of water. The x-axis specifies the position of a point in a direction parallel to the length of the streamers or the direction of the survey vessel and is referred to as the “in-line” direction. The y-axis specifies the position of a point in a direction perpendicular to the x-axis and substantially parallel to the free surface 112 and is referred to as the “cross-line” direction. The z-axis, also referred to as the “depth” axis, specifies the position of a point in a direction perpendicular to the xy-plane (i.e., perpendicular to the free surface 112) with the positive z-direction pointing downward away from the free surface 112.

The streamers 106-111 are typically long cables containing power and data-transmission lines coupled to receivers (represented by shaded rectangles) such as receiver 118 that are spaced-apart along the length of each streamer. The data transmission lines couple receivers to seismic data acquisition equipment, computers, and data-storage devices located onboard the survey vessel 102. Streamer depth below the free surface 112 can be estimated at various locations along the streamers using depth-measuring devices attached to the streamers. For example, the depth-measuring devices can measure hydrostatic pressure or utilize acoustic distance measurements. The depth-measuring devices can be integrated with depth controllers, such as paravanes or water kites that control and maintain the depth and position of the streamers as the streamers are towed through the body of water. The depth-measuring devices are typically placed at intervals (e.g., about 300-meter intervals in some implementations) along each streamer. Note that in other implementations buoys may be attached to the streamers and used to maintain the orientation and depth of the streamers below the free surface 112.

In FIG. 1A, curve 122, the formation surface, represents a top surface of the subterranean formation 120 located at the bottom of the body of water. The subterranean formation 120 may include many subterranean layers of sediment and rock. Curves 124, 126, and 128 represent interfaces between subterranean layers of different compositions. A shaded region 130, bounded at the top by a curve 132 and at the bottom by a curve 134, represents a subterranean hydrocarbon deposit, the depth and positional coordinates of which may be determined, at least in part, by analysis of seismic data collected during a marine seismic survey. As the survey vessel 102 moves over the subterranean formation 120, the vibrational source 104 produces acoustic energy over time that spreads out in all directions away from the vibrational source 104. For the sake of simplicity, FIG. 1 A shows acoustic energy expanding outward from the vibrational source 104 as a pressure wavefield 136 represented by semicircles of increasing radius centered at the vibrational source 104. The outwardly expanding wavefronts from the vibrational source may be spherical but are shown in vertical plane cross section in FIG. 1A. The outward and downward expanding portion of the pressure wavefield 136 is called the “source wavefield” and any portion of the pressure wavefield 136 reflected downward from the free-surface 112 is called the “source ghost wavefield.” The source wavefield 136 eventually reach the formation surface 122 of the subterranean formation 120, at which point the wavefields may be partially reflected from the formation surface 122 and partially refracted downward into the subterranean formation 120, becoming elastic waves within the subterranean formation 120. In the body of water, the source wavefield primarily comprises compressional pressure waves, or P-waves, while in the subterranean formation 120, the waves include both P-waves and transverse waves, or S-waves. Within the subterranean formation 120, at each interface between different types of materials or at discontinuities in density or in one or more of various other physical characteristics or parameters, downward propagating waves may be partially reflected and partially refracted. As a result, each point of the formation surface 122 and each point of the interfaces 124, 126, and 128 may be a reflector that becomes a potential secondary point source from which acoustic and elastic wave energy, respectively, may emanate upward toward the receivers 118 in response to the acoustic signals generated by the vibrational source 104. As shown in FIG. 1A, waves of significant amplitude may be generally reflected from points on or close to the formation surface 122, such as point 138, and from points on or very close to interfaces in the subterranean formation 120, such as points 140 and 142.

The waves comprising the reflected wavefield may be generally reflected at different times within a range of times following the source wavefield. A point on the formation surface 122, such as the point 138, may receive a pressure disturbance from the source wavefield more quickly than a point within the subterranean formation 120, such as point 142. Similarly, a point on the formation surface 122 directly beneath the vibrational source 104 may receive the pressure disturbance sooner than a more distant-lying point on the formation surface 122. Thus, the times at which waves are reflected from various points within the subterranean formation 120 may be related to the distance, in three-dimensional space, of the points from the vibrational source 104.

Acoustic and elastic waves may travel at different velocities within different materials as well as within the same material under different pressures. Therefore, the travel times of the source wave field and reflected wavefield may be functions of distance from the source as well as the materials and physical characteristics of the materials through which the wavefields travel. In addition, expanding wavefronts of the wavefields may be altered as the wavefronts cross interfaces and as the velocity of sound varies in the media traversed by the wavefront. The superposition of waves reflected from within the subterranean formation 120 in response to the source wavefield may be a generally complicated wavefield that includes information about the shapes, sizes, and material characteristics of the subterranean formation 120, including information about the shapes, sizes, and locations of the various reflectors within the subterranean formation 120 of interest to exploration seismologists.

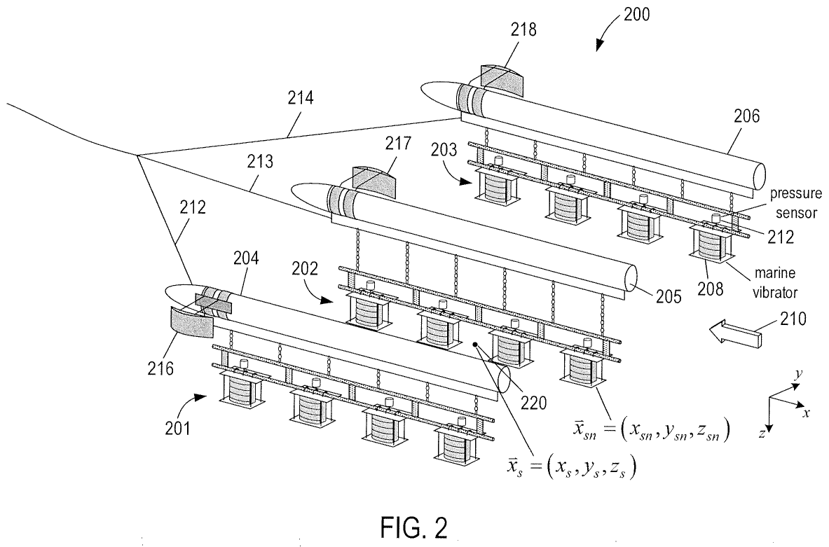

The vibrational source 104 may comprise a single marine vibrator or an array of marine vibrators. FIG. 2 shows an isometric view of an example vibrational source 200 comprising an array of marine vibrators. The array of marine vibrators comprises three sub-arrays 201-203 of marine vibrators. Each marine vibrator is suspended from one of three floats 204-206. For example, sub-array 203 includes a float 206 with four marine vibrators, such as marine vibrator 208, suspended below the float 206 in the body of water. In other implementations, each sub-array also includes pressure sensors. Each marine vibrator has a corresponding pressure sensor that measures a pressure wavefield created by the corresponding marine vibrator as the source 200 moves in the direction represented by directional arrow 210. For example, pressure sensor 212 may be located approximately 1 m from corresponding marine vibrator 208. Each marine vibrator may also have a motion sensor mounted on the vibrating plates to record the vibrational signature of the marine vibrator. The sub-arrays are connected to cables 212-214 that include electrical wires that transmit electrical activation signals to each marine vibrator and transmit electrical signals generated by each pressure sensor or motion sensor back to the surveys vessel. The vibrational source 200 includes steering devices 216-218 that may be used to steer and control the direction of the vibrational source 200 while being towed through the body of water. Point 220 represents the geometrical center of the marine vibrators with Cartesian coordinates denoted by [symbol] ₛ=(xₛ, yₛ, xₛ). The Cartesian coordinates of each marine vibrator are denoted by [symbol] ₛₙ=(xₛₙ, yₛₙ, xₛₙ), where subscript “n” is a marine vibrator index. Each marine vibrator emits acoustic energy in the form of rapidly oscillating pressure wavefield that spread outward in all directions and is called a “vibroseis sweep” or simple a “sweep.” A sweep measured by a collocated pressure sensor and is denoted by s(t, [symbol] ₛₙ). Note that vibrational sources are not limited to the example of twelve marine vibrators shown in FIG. 2. For example, the vibrational source 104 may have as few as one marine vibrator or as many as ten or more marine vibrators.

A sweep emitted from a marine vibrator has a bandlimited frequency that increases over the duration of the sweep and has an amplitude that tapers at the beginning and end of the sweep. The pressure sensor or motion sensor located adjacent to the marine vibrators as described above with reference to FIG. 2 records the time-dependent frequency and amplitude characteristics of a sweep as a sweep signature. In the following description, mathematical models of pressure wavefields emitted from marine vibrators are used to represent sweep signatures, present terminology associated with sweeps, and describe physical properties and characteristics of actual sweeps emitted from actual marine vibrators that are operated as described herein. The mathematical models are not intended to limit the functionality and operations of marine vibrators or limit the various types of actual sweeps that may be emitted from actual marine vibrators as described below. In the following description. a sweep signature of an oscillating pressure wavefield emitted from a marine vibrator is mathematically modeled by the following expression:

s(t)=a(t) sin[2πθ(t)t] (1)

where
a(t) represents a time-dependent amplitude of the sweep;
θ(t) represents a time-dependent frequency of the sweep; and
t is time.

In Equation (1), the marine vibrator coordinate [symbol] ₛₙ is suppressed. The amplitude a(t) has units of pressure. The sinusoidal term, sin[2πθ(t)t], models oscillations in a sweep over time. The frequency θ(t) has units of inverse time and is equivalent to the actual vibrational frequency of the marine vibrator. The quantity 2πθ(t) is a time-dependent angular frequency with units of radians per unit of time. A sweep is generated over a time period called a sweep duration. Let T denote the sweep duration with 0≤t≤T.

The frequency of a sweep may he mathematically modeled by the following expression:

$$θ ( t ) = {f}_{0} + ( \frac{df}{dt} ) t \qquad ( 2 )$$

where
f₀ is an initial frequency of the sweep emitted from a marine vibrator at the start of a sweep; and
df/dt, is the rate at which the frequency of the sweep changes over time.
   A marine vibrator may be operated to emit a sweep with a frequency that continuously increases (i.e., an upsweep with θ(t)>0) or continuously decreases i.e., a downsweep with θ(t)<0) for the duration of the sweep. A sweep begins with the initial frequency f₀ at the start of the sweep and stops with a final frequency denoted by f₁ (i.e., f₁=f₀+(df/dt)T). A marine vibrator emits a sweep with frequencies that lie within a sweep-frequency range defined by the initial frequency f₀ and the final frequency f₁. Marine vibrators may be configured and/or operated to emit sweeps with frequencies that rapidly increase toward the end of the sweep (e.g., non-linear exponentially increasing frequencies). Marine vibrators may be configured and/or operated to emit linear sweeps (i.e., df/dt is constant) with frequencies that linearly increase (or decrease) for the duration of the sweep. Marine vibrators may be configured and/or operated to emit sweeps with frequencies that rapidly increase at the beginning of the sweep and flatten toward the end of the sweep (e.g., non-linear logarithmically increasing frequencies).

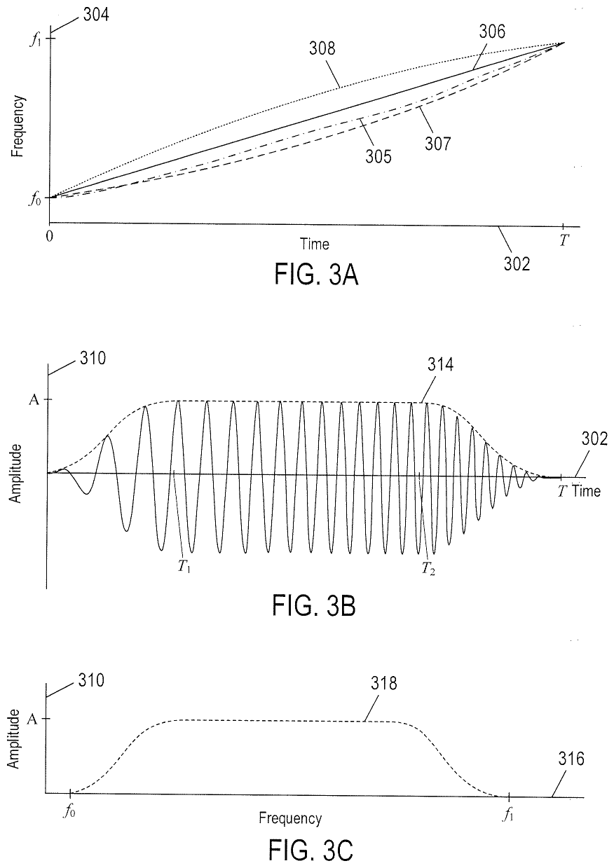

FIG. 3A shows a plot of example increasing frequencies of sweeps that may be produced by marine vibrators. Horizontal axis 302 represents time. Vertical axis 304 represents a range of frequencies. The sweeps have the same sweep duration T identified on the time axis 302. Initial frequency f₀ and final frequency f₁ of the sweep are marked on the frequency axis 304 and are limits of a sweep-frequency range. Curves 305-308 represent four different, ways sweeps with increasing frequencies may be emitted from marine vibrators over approximately the same sweep duration and within approximately the same sweep-frequency range. Curve 305 represents frequencies that increase in an uneven non-linear manner f)r the duration of the sweep. Line 306 represents frequencies that increase linearly over for the duration of the sweep. Dashed curve 307 represents exponentially increasing frequencies for the duration of the sweep. Dotted curve 308 represents frequencies that logarithmically increases for the duration of the sweep.

The amplitude of a sweep tapers at the beginning and end of a sweep. FIG. 3B shows a plot of an example sweep signature of a sweep produced by a marine vibrator. Vertical axis 310 represents an amplitude range for the sweep. Oscillating curve 312 represents an example sweep signature with a frequency that increases for the duration of the sweep. Dashed curve 314 represents an envelope of the time-dependent amplitude of the sweep. In this example, the maximum amplitude of the sweep is denoted by A. Time T₁ is the end time of a first taper zone. Time T₂ is the start time of a second taper zone. The amplitude increases over a first taper zone between time zero and time T₁ maintains the maximum amplitude A between times T₁ and T₂ and decreases over a second taper zone beginning at time T₂ and ending at time T.

The sweep signature shown in FIG. 3B, and the examples of sweep signatures in subsequent figures, exhibit a smooth amplitude oscillation. The smooth oscillations of the sweep signatures illustrated herein are not intended to imply that amplitudes of actual sweeps emitted from actual marine vibrators exhibit the same smoothly varying amplitudes over the sweep duration. The amplitudes of an actual sweep may vary over the duration of the sweep.

FIG. 3C shows a plot of an example frequency spectrum of a sweep. Horizontal axis 316 represents a range of frequencies that includes the initial frequency f₀ and final frequency f₁ of a sweep-frequency range. Dashed curve 318 represents change in the amplitude of a sweep over the sweep-frequency range. The amplitude gradually increases after the initial frequency f₀ maintains the maximum amplitude A and decreases to zero as the sweep reaches the final frequency f₁.

Marine vibrators are operated as described herein to generate sweeps with randomized phases and/or randomized sweep durations. A parameter, ϕ_{rand}, represents a randomly selected phase angle with units of radians, where −π<ϕ_{rand}≤π. A marine vibrator is operated to emit a sweep with a randomized phase. The sweep signature of a sweep generated with a randomized phase may be mathematically modeled as follows:

s(t)=a(t)sin[2πθ(t)t±ϕ_{rand}] (3)

The randomized phase ϕ_{rand} shifts angular dependence of the sweep. A positive valued phase, +ϕ_{rand}, shifts the angle of the sweep signature forward in the angle domain. A negative valued phase, −ϕ_{rand}, shifts the angle of the sweep signature backward in the angle domain. The randomized phase may be determined by letting h be a randomly generated number that satisfies the condition −1≤b≤1. The randomized phase may be given by ϕ_{rand}=πb. When sweeps are emitted from a vibration source with different phases that vary in a systematic manner the sweeps are coherent.

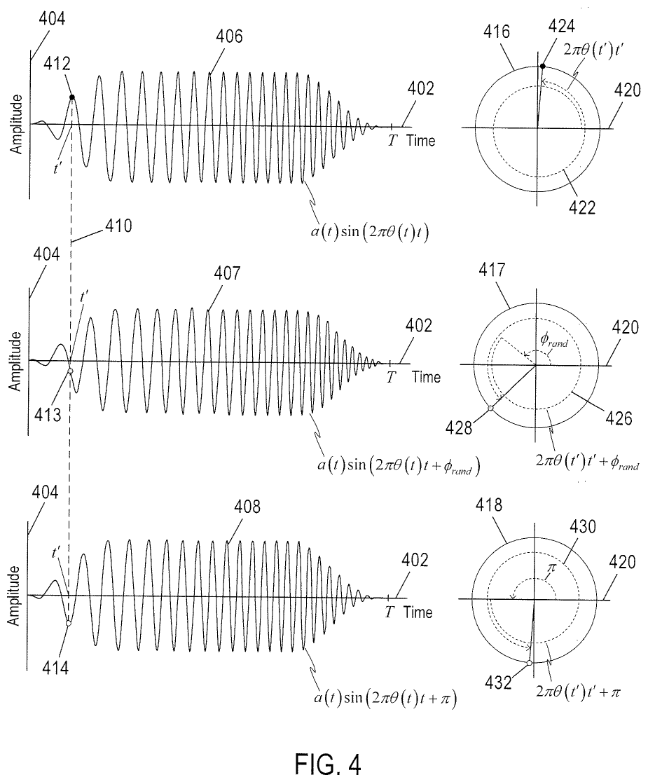

FIG. 4 shows a plot of example sweep signatures of sweeps emitted from a marine vibrator with the same sweep duration but with different phases. Horizontal axes 402 represent time. Vertical axes 404 represent amplitude. Oscillating curves 406-408 represent sweep signatures of three different sweeps emitted from a marine vibrator with the same sweep duration T but with different phases. Sweep signature 406 represents a sweep emitted with a zero phase. Sweep signature 407 represents a sweep emitted with a randomized phase ϕ_{rand} that is less than π radians. Sweep signature 408 represents a sweep emitted with a randomized phase ϕ_{rand} that is equal to π radians. Dashed line 410 corresponds to the same point in time t′ for the sweep signatures 406-408. Although the sweeps represented by the sweep signatures 406-407 are emitted with the same duration and same frequency range, oscillations in amplitudes of the sweep signatures are not synchronized because of the different phases. For example, dots 412-414 identify amplitudes of the corresponding sweep signatures 406-408 at the same point in time t′ after the beginning of the sweeps. The amplitude 412 at time t′ is different from the amplitude 413 and the amplitude 414 at time t′ is reversed with respect to the amplitude 412. FIG. 4 shows unit circles 416-418 that represent angles dependence of the three different sweep signatures 406-408 at time t′. Each unit circle is centered at an angular coordinate system with horizontal line segment 420 corresponding to 2πn radians, where n= . . . , −2, −1, 0, 1, 2, . . . . Spiral 422 represents an angle 2πθ(t′)t′ that begins at zero radians, ends at point 424 on the unit circle 416, and corresponds to oscillations in the amplitude of the sweep signature 406 up to time t′. Spiral 426 represents an angle 2πθ(t′)t′+ϕ_{rand} that begins at randomly selected phase ϕ_{rand} radians, ends at a point 428 on the unit circle 417, and corresponds to oscillations in the amplitude of the sweep signature 407 up to time t′. Spiral 430 represents an angle 2πθ(t′)t′+π that begins with randomly selected phase π radians, ends at a point 432 on the unit circle 418, and corresponds to oscillations in the amplitude of the sweep signature 408 up to time t′.

A parameter, T_{rand}, represents the duration of a randomized sweep duration that lies within an interval Tₘᵢₙ≤T_{rand}≤Tₘₐₓ, where Tₘᵢₙ and Tₘₐₓ are minimum and maximum duration limits, respectively, of a randomized sweep duration. The duration of a randomized sweep duration may be determined by letting q be a randomly generated number that satisfies the condition 0≤q≤1. The duration of randomized sweep duration may be given by T_{rand}=(Tₘₐₓ−Tₘᵢₙ)q+Tₘᵢₙ. A marine vibrator may be configured and/or operated to generate sweeps that span the same sweep-frequency range within different randomized sweep durations.

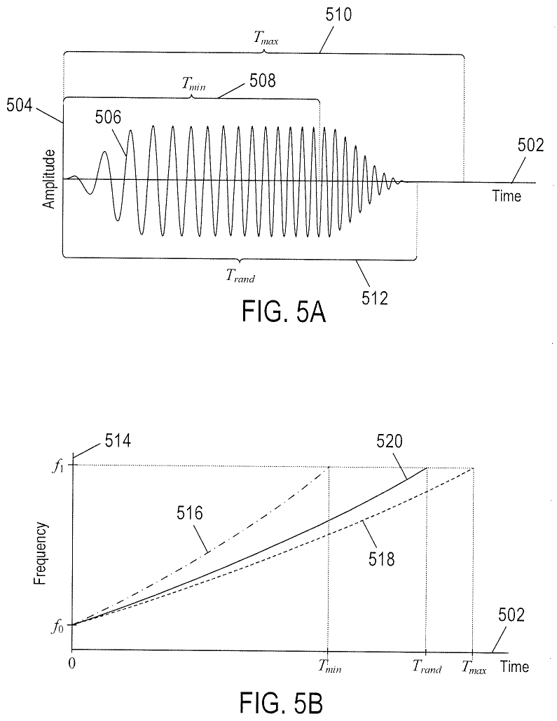

FIG. 5A shows a plot of an example of a sweep signature of a sweep emitted from a marine vibrator with a randomized sweep duration. Horizontal axis 502 represents time. Vertical axis 504 represents amplitude. Curve 506 represents a sweep signature of a sweep emitted from a marine vibrator. Bracket 508 represents a minimum sweep duration. Tₘᵢₙ. Bracket 510 represents a maximum sweep duration, Tₘₐₓ. Bracket 512 represents the randomized sweep duration, T_{rand}. FIG. 5B shows a plot of an example frequencies of sweeps emitted from a marine vibrator with a minimum sweep duration, a maximum sweep duration, and a randomized sweep duration. Vertical axis 514 represents a range of frequencies between the initial frequency f₀ and final frequency f₁ of sweeps generated by the marine vibrator. Dashed-dotted curve 516 represents the frequencies of a sweep emitted from the marine vibrator activated with the minimum sweep duration 508. Dashed curve 518 represents the frequencies of a sweep emitted from the marine vibrator activated with the maximum sweep duration. Curve 520 represents the frequencies of a sweep emitted from the marine vibrator activated with the randomized sweep duration 512. The marine vibrator generates sweeps that span the same sweep-frequency range but are within different sweep durations.

A series of non-overlapping sweeps may be emitted from repeated activation of a marine vibrator where each sweep is emitted with a randomized phase and/or with a randomized sweep duration. A series of sweeps emitted from a single marine vibrator with randomized phases and/or randomized sweep durations and with no time delay between successively emitted sweeps produces a continuous source wavefield. By randomizing the phase and sweep durations of each sweep, spatial aliasing and residual crosstalk noise is reduced in the common receiver domain.

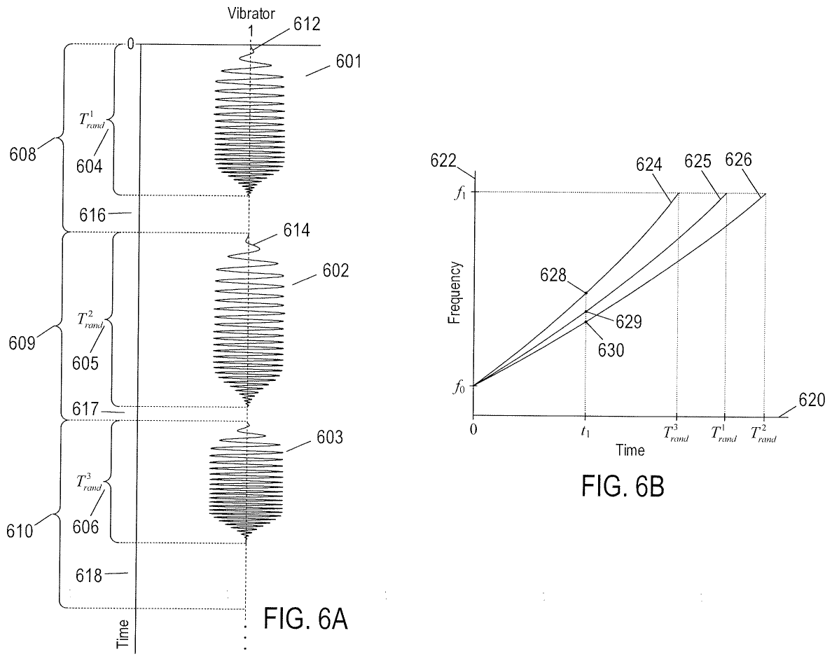

FIG. 6A shows an example of sweep signatures 601-603 of three successive sweeps emitted from a marine vibrator with randomized phases and with randomized sweep durations. The three sweeps are emitted with randomized sweep durations 604-606 denoted by T_{rand}¹, T_{rand}², and T_{randpp3} and with different randomized phases. The three sweeps are also emitted in three corresponding sweep intervals 608-610. For example, amplitude oscillations near the beginning 612 of the sweep signature 601 are not synchronized with amplitude oscillations near the beginning 614 of the sweep signature 602. In FIG. 6A, because the sweep intervals are larger than the randomized sweep durations, the sweeps are separated in time by randomized time delays 616, 617, and 618 that separate the ending time of one sweep from the beginning time of a subsequent sweep. For example, randomized time delay 616 separates the ending time of the sweep signature 601 from the beginning time of the sweep signature 602. The random time delays may be generated using a random time generator and/or may be the result of stopping and restarting the same marine vibrator to generate a next sweep. In other implementations, the sweeps may be emitted with no time delay. In other words, when the randomized sweep durations are equal to the corresponding sweep intervals, each sweep is generated immediately after the end of a previous sweep.

The frequencies of sweeps emitted with randomized phases and/or randomized sweep durations are different at corresponding points in time after the start of each sweep. FIG. 6B shows a plot of example frequencies of the three sweeps represented by sweep signatures in FIG. 6A. Horizontal axis 620 represents time. Vertical axis 622 represents a range of frequencies with the initial frequency f₀ and final frequency f₁ of sweeps generated by the marine vibrator. In this example, the marine vibrator emits seeps with an increasing non-linear frequency. Curve 624 represents frequencies of the sweep represented by sweep signature 603. Curve 625 represents frequencies of the sweep represented by sweep signature 601. Curve 626 represents the frequencies of the sweep represented by sweep signature 602. Points 628-629 represent different frequencies in the three different sweeps emitted at the same time t₁ after the beginning of the sweep intervals 608-610. Curves 624-626 reveal that although the sweeps are emitted from the marine vibrator with different sweep durations, the sweeps span the same sweep-frequency range.

Sweeps may also be emitted from multiple marine vibrators of a vibrational source. Each sweep is emitted with a randomized phase and/or with a randomized sweep. In certain implementations, the sweeps may be emitted from multiple marine vibrators with no time delay between the ending of one sweep and the beginning of a next sweep. In other implementations, the sweeps may be emitted from multiple marine vibrators with randomized time overlap such that one marine vibrator starts emitting a sweep before one or more other marine vibrators have finished emitting one or more sweeps. In other words, two sweeps emitted from two different marine vibrators are said to overlap when one of the marine vibrators begins emitting one of the sweeps while the other marine vibrator is in the process of emitting the other sweep. The sweeps emitted from multiple marine vibrators with randomized phases and/or randomized sweep durations and with overlap and/or no time delay between successive sweeps produce a continuous source wavefield. By randomizing the phase and sweep durations at the start time of each sweep spatial aliasing and residual crosstalk noise are reduced in the common receiver domain.

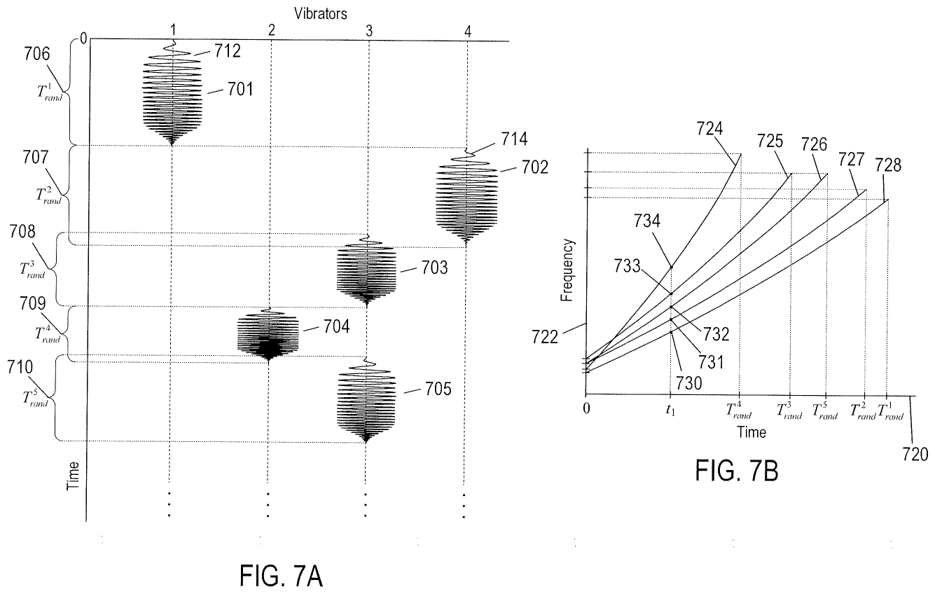

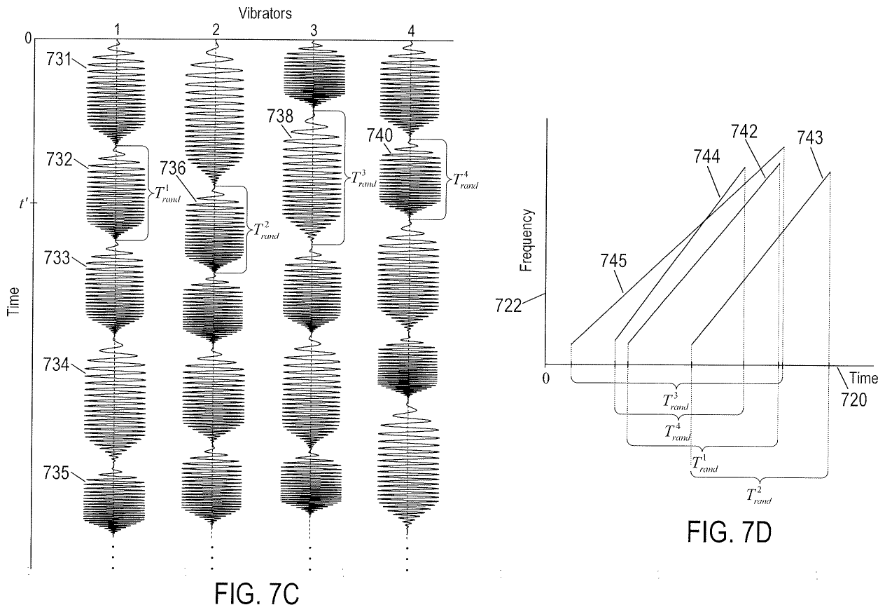

FIG. 7A shows sweep signatures 701-705 that represent five example sweeps emitted from four marine vibrators of a vibrational source with randomized phases and with randomized sweep durations 706-710 denoted by T_{rand}¹, T_{rand}², T_{rand}³, T_{rand}⁴, and T_{rand}⁵. For example, amplitude oscillations near the beginning 712 of the sweep signature 701 is not synchronized with amplitude oscillations near the beginning 714 of the sweep signature 702. In this example, none of the sweeps are separated by a time delay. The sweep represented by the sweep signature 702 is emitted from marine vibrator 4 without a time delay immediately following the sweep represented by the sweep signature 701. The sweep represented by sweep signature 704 is emitted from marine vibrator 2 without a time delay immediately following the sweep represented by the sweep signature 703. The sweep represented by the sweep signature 703 overlaps with the sweep represented by the sweep signature 702. The sweep represented by the sweep signature 705 overlaps with the sweep represented by the sweep signature 704.

In other implementations, the sweeps may be emitted with a random time delay between successive sweeps. The random time delay may be generated using a random time generator and/or due to the time it takes to stop one marine vibrator and restart a different marine vibrator after the ending of a previously emitted sweep. In still other implementations, successive sweeps may be emitted from multiple marine vibrators with any combination of no time delays, overlapping sweeps, and random time delays.

The frequencies of sweeps emitted from two or more marine vibrators with randomized phases and/or randomized sweep durations are different at corresponding points in time after the start of each sweep. Because the phases and sweep durations are randomized from one sweep to the next sweep, the marine vibrators do not emit sweeps with the same frequency at the same time and the frequencies of the sweeps vary at all times.

FIG. 7B shows a plot of example frequencies of the five sweeps represented by sweep signatures in FIG. 7A. Horizontal axis 720 represents time. Vertical axis 722 represents a range of frequencies. Curves 724-728 represent frequencies of the sweeps emitted from the marine vibrators 1-4 in FIG. 7A. In this example, each marine vibrator emits a non-linear sweep in a corresponding sweep-frequency range identified by marks on the frequency axis 722. Curve 724 represents frequencies of the sweep with sweep signature 704. Curve 725 represents frequencies of the sweep with sweep signature 703. Curve 726 represents frequencies of the sweep with sweep signature 705. Curve 727 represents frequencies of the sweep with sweep signature 714. Curve 728 represents the frequencies of the sweep with sweep signature 712. Points 730-734 represents different frequencies in the five sweeps emitted at the same time t₁ after the beginning of each of the sweep. Curves 724-728 represent different frequency ranges of the five sweeps emitted in with different sweep durations. The sweeps emitted from the four different marine vibrators span different sweep-frequency ranges. In other implementations, the two or more marine vibrators of a vibrational source may be configured and operated to generate sweeps that span the same sweep-frequency range.

In other implementations, the marine vibrators of a vibrational source may be independently operated such that each marine vibrator continuously emit sweeps with randomized phases and/or randomized sweep durations and without a time delay between consecutively emitted sweeps. As a result, the sweeps produced by the multiple marine vibrators overlap in time at different frequencies and with different phases to form a continuous source wavefield.

FIG. 7C shows an example of sweep signatures of overlapping continuously emitted sweeps from each of four marine vibrators of a vibrational source. Each of the four marine vibrators independently emits a series of sweeps without time delays between consecutive sweeps. Each sweep is emitted with a randomized phases and randomized sweep durations. For example, sweep signatures 731-735 represent five consecutive sweeps emitted from marine vibrator 1 with no time delays and with different randomized phases and randomized sweep durations. Because the sweeps are independently and continuously emitted from each marine vibrator with no time delays and with a randomized phase and randomized sweep duration, the sweeps emitted from the marine vibrator overlap in time. For example, the sweep signatures 732, 736, 738, and 740 represent four sweeps emitted from the four marine vibrators with different phases and with different corresponding sweep durations denoted by T_{rand}¹, T_{rand}², T_{rand}³, and T_{rand}⁴ that overlap in time.

FIG. 7D shows a plot of example frequencies of the four sweeps represented by sweep signatures 732, 736, 738, and 740 in FIG. 7C, Line 742-745 represent frequencies of the sweeps emitted from the marine vibrators 1-4 in FIG. 7C. In this example, each marine vibrator emits a linear sweep over a different corresponding sweep-frequency range and with a different sweep duration. Line 742 represents frequencies of the sweep with the sweep signature 732. Line 743 represents frequencies of the sweep with sweep signature 736. Line 744 represents frequencies of the sweep with the sweep signature 738. Line 745 represents frequencies of the sweep with the sweep signature 740. As shown in FIG. 7D, the sweep durations overlap and the resulting continuous source wavefield is composed of sweeps with different frequencies at different points in time.

In certain implementations, parameters representing the randomize phases and/or randomized sweep durations of sweeps described above may be generated by a source control or another computer system onboard the survey vessel towing the vibrational source while the survey vessel travels a sail line. In other implementations, parameters representing the randomize phases and/or randomized sweep durations of sweeps may be generated by the source control or another computer system onboard the survey vessel prior to performing a marine survey followed by emitting sweeps in accordance with the predetermined randomize phases and/or randomized sweep durations.

When sweeps are generated with a randomized phase and/or with a randomized sweep duration as described above with reference to FIGS. 6A-7D, there is no specific frequency or wavenumber where spatial aliasing in the common receiver domain begins, In other words, traces of seismic data recorded by receivers of the seismic data acquisition surface shown in FIGS. 1A-1B for sweeps emitted with a randomized phase and/or with a randomized sweep duration, as described above with reference to FIGS. 6A-7D, may be sorted into the common receiver domain with reductions in spatial aliasing and reductions in crosstalk noise.

Each receiver 118 of the seismic data acquisition surface shown in FIGS. 1A-1B comprises a multicomponent sensor including at least one particle motion sensor and a pressure sensor. A pressure sensor detects variations in water pressure over time. The term “particle motion sensors” is a general term used to refer to a sensor that may be configured to detect particle displacement, particle velocity, or particle acceleration over time or more axes.

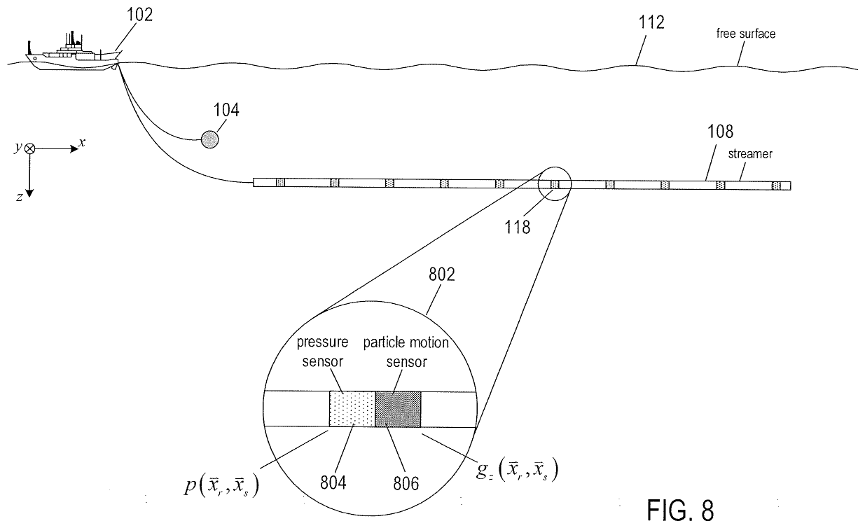

FIG. 8 shows a side-elevation view of the marine seismic data acquisition system with a magnified view 802 of the receiver 118. In this example, the magnified view 802 reveals that the receiver 118 is a multicomponent sensor comprising a pressure sensor 804 and a particle motion sensor 806. The pressure sensor may be, for example, a hydrophone. Each pressure sensor is a non-directional sensor that measures changes in a hydrostatic pressure wavefield over time to produce pressure wavefield data denoted by p( [symbol] ᵣ, [symbol] ₛ, t), where t represents time, and [symbol] ᵣ represents the Cartesian coordinates (xᵣ, yᵣ, zᵣ) of a receiver. The particle motion sensors are directional sensors that are responsive to water motion in a direction. In general, particle motion sensors detect particle motion (i.e., displacement, velocity, or acceleration) in a direction and may be responsive to such directional displacement of the particles, velocity of the particles, or acceleration of the particles. A particle motion sensor that measures particle displacement generates particle displacement data denoted by [symbol] ( [symbol] ᵣ, [symbol] ₛ, t), where the vector [symbol] represents the direction along which particle displacement is measured. A particle motion sensor that measures particle velocity (i.e., particle velocity sensor) generates particle velocity wavefield data denoted by [symbol] ( [symbol] ᵣ, [symbol] ₛ, t). A particle motion sensor that measures particle acceleration (i.e., accelerometer) generates particle acceleration data denoted by [symbol] ( [symbol] ᵣ, [symbol] ₛ, t). The data generated by one type of particle motion sensor may be converted to another type. For example, particle displacement data may be differentiated to obtain particle velocity wavefield data, and particle acceleration data may be integrated to obtain particle velocity data.

The term “particle motion data” refers to particle displacement data, particle velocity wavefield data, or particle acceleration data. The term “seismic data” refers to pressure wavefield data and/or particle motion data. Pressure wavefield data may also be called the “pressure wavefield.” Particle displacement data represents a particle displacement wavefield, particle velocity wavefield data represents a particle velocity wavefield, and particle acceleration data represents a particle acceleration wavefield. The particle displacement, velocity, and acceleration wavefield data are correspondingly called particle displacement, velocity, and acceleration wavefields.

The particle motion sensors are typically oriented so that the particle motion is measured in the vertical direction (i.e., [symbol] =(0, 0, z)) in which case g_{z}( [symbol] ᵣ, [symbol] ₛ, t) is called vertical wavefield displacement data, v_{z}( [symbol] ᵣ, [symbol] ₛ, t) is called vertical velocity wavefield, and a_{z}( [symbol] ᵣ, [symbol] ₛ, t) is called vertical acceleration wavefield. The vertical downward direction of the particle motion sensors in a horizontal streamer may be achieved by employing gimbaling devices that enable the particle motion sensors to remain effectively horizontal to the water surface even as the streamer undulates in the body of water. In other words, the gimbaling devices enable the particle motion sensors to measure particle motion in the normal direction to the water surface even though the streamers may be tilted or curved (e.g., gₙ( [symbol] ᵣ, [symbol] ₛ, t)). Alternatively, each receiver may include two additional particle motion sensors that measure particle motion in two other directions, [symbol] ₁ and [symbol] ₂, that are orthogonal to [symbol] (i.e., [symbol] · [symbol] ₁= [symbol] · [symbol] ₂=0, where “·” is the scalar product) and orthogonal to one another (i.e., [symbol] ₁· [symbol] ₂=0). In other words, each receiver may include three particle motion sensors that measure particle motion in three orthogonal directions. For example, in addition to having a particle motion sensor that measures particle velocity in the z-direction to give v_{z}( [symbol] ᵣ, [symbol] ₛ, t), each receiver may include a particle motion sensor that measures the wavefield in the in-line direction in order to obtain the in-line velocity wavefield, vₓ( [symbol] ᵣ, [symbol] ₛ, t), and a particle motion sensor that measures the wavefield in the cross-line direction in order to obtain the cross-line velocity wavefield, v_{y}( [symbol] ᵣ, [symbol] ₛ, t). The three orthogonal velocity wavefields form a velocity wavefield vector [symbol] =(vₓ, v_{y}, v_{z}). In certain implementations, the receivers may be only pressure sensors, and in other implementations, the receivers may be only particle motion sensors.

The streamers 106-111 and the survey vessel 102 may include sensing electronics and data-processing facilities that allow seismic data generated by each receiver to be correlated with the time each source is activated, absolute positions on the free surface 112, and absolute three-dimensional positions with respect to an arbitrary three-dimensional coordinate system. The pressure wavefield and particle motion wavefield may be stored at the receiver and/or may be sent along the streamers and data transmission cables to the survey vessel 102, where the data may be stored electronically, magnetically, or optically on data-storage devices located onboard the survey vessel 102 and/or transmitted onshore to data-storage devices located in a seismic data-processing facility.

Subterranean formations located beneath a body of water may also be surveyed using ocean bottom seismic techniques. In one implementation, these techniques may be performed with ocean bottom cables (“OBCs”) laid on or near the water bottom. The OBCs are similar to towed streamers described above in that the OBCs include spaced-apart receivers. such as collocated pressure and particle motion sensors, deployed approximately every 25 to 50 meters. In other implementation, ocean bottom nodes (“OBNs”) may be deployed along the formation surface. Each node may have collocated pressure and particle motion sensors The OBCs and OBNs may be electronically connected to an anchored recording vessel that provides power, instrument command and control of the pressure and/or vertical velocity data sent to recording equipment located on board the vessel. Traces of continuously recorded seismic data using streamers, as described above, OBCs, or OBNs may processed as described below.

Each pressure sensor and particle motion sensor may include an analog-to-digital converter that converts time-dependent analog signals into discrete time series data that consist of consecutively measured values called “amplitudes” separated in time by a sample rate. The time series data generated by a pressure or particle motion sensor is called a “trace,” which may consist of thousands of samples collected at a typical sample rate of about 1 to 5 samples per millisecond. A trace includes a recording of a subterranean formation response to acoustic energy that passes from an activated source, into the subterranean formation where a portion of the acoustic energy is reflected and/or refracted, and ultimately detected by a sensor as described above. Each trace records variations in time-dependent amplitudes that correspond to fluctuations in acoustic energy of the wavefield measured by the sensor. In general, each trace is an ordered set of discrete spatial and time-dependent pressure or motion sensor amplitudes denoted by:

tr( [symbol] ᵣ, [symbol] ₛ,t)={A( [symbol] ᵣ, [symbol] ₛ,tₗ)}ₗ₌₀^{L-1} (4)

where
tr represents pressure, particle displacement, particle velocity, or particle acceleration amplitude;
A represents amplitude;
tₗ is the l-th sample time; and
L is the number of time samples in the trace.
   The coordinate location [symbol] _{R} of each receiver may be calculated from global position information obtained from one or more global positioning devices located along the streamers and/or the towing vessel, from depth measuring devices, such as hydrostatic pressure sensors, and the known geometry and arrangement of the streamers and receivers. The receiver and source locations varies with time and may also be denoted by [symbol] ᵣ= [symbol] ᵣ(t)=(xᵣ(t), yᵣ(t), zᵣ(t)) and [symbol] ₛ= [symbol] ₛ(t)=(xₛ(t), yₛ(t), zₛ(t)). Each trace also includes a trace header not represented in Equation (1) that identifies the specific receiver that generated the trace, receiver and source GPS spatial coordinates, receiver depth, and may include tine sample rate and the number of time samples.

Reflected wavefields from the subterranean formation typically arrive first at the receivers located closest to the sources. The distance from the sources to a receiver is called the “source-receiver offset,” or simply “offset.” A larger offset generally results in a longer arrival time delay. The traces are collected to form a “gather” that can be further processed using various seismic data processing techniques to obtain information about the structure of the subterranean formation. The traces may be sorted into different domains, such as a common-shot domain, common receiver domain, common-receiver-station domain, and common-midpoint domain. For example, a collection of traces sorted into the common-shot domain are called a common-shot gather and a collection of traces sorted into common receiver domain are called a common receiver gather. The portion of the acoustic signal that is reflected into the body of water from the subterranean formation and that travels directly to the receivers is called a primary reflected wavefield or simply a “primary.” Other portions of the acoustic energy that are reflected upward into the body of water and that reverberate between the free surface and the subterranean formation before reaching the receivers are called free-surface multiple reflected wavefields or simply “free-surface multiples:” Other portions of the acoustic energy that are reflected upward into the body of water directly to receivers after having reverberated within the subterranean formation are called subsurface multiple reflections or simply subsurface multiples.

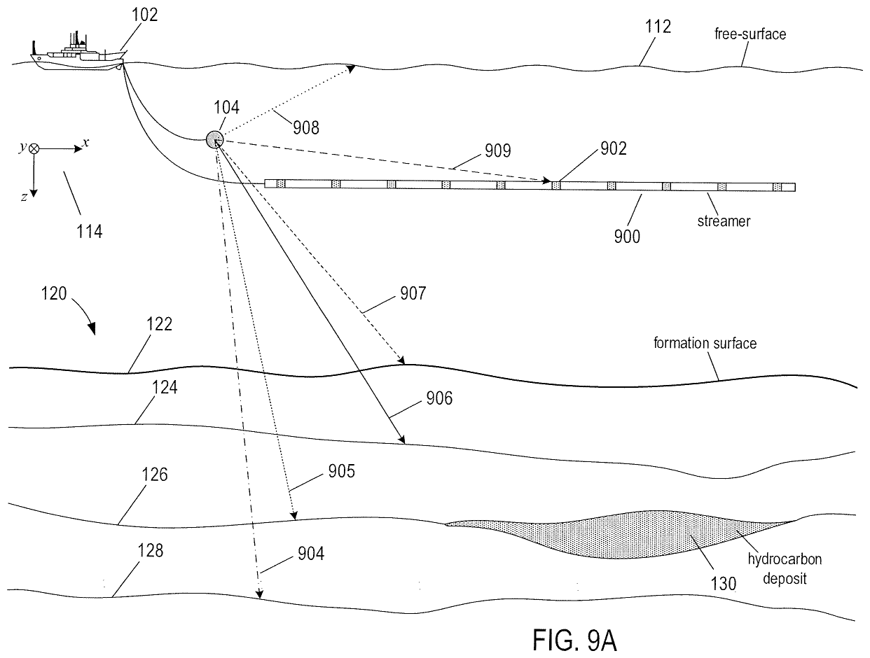

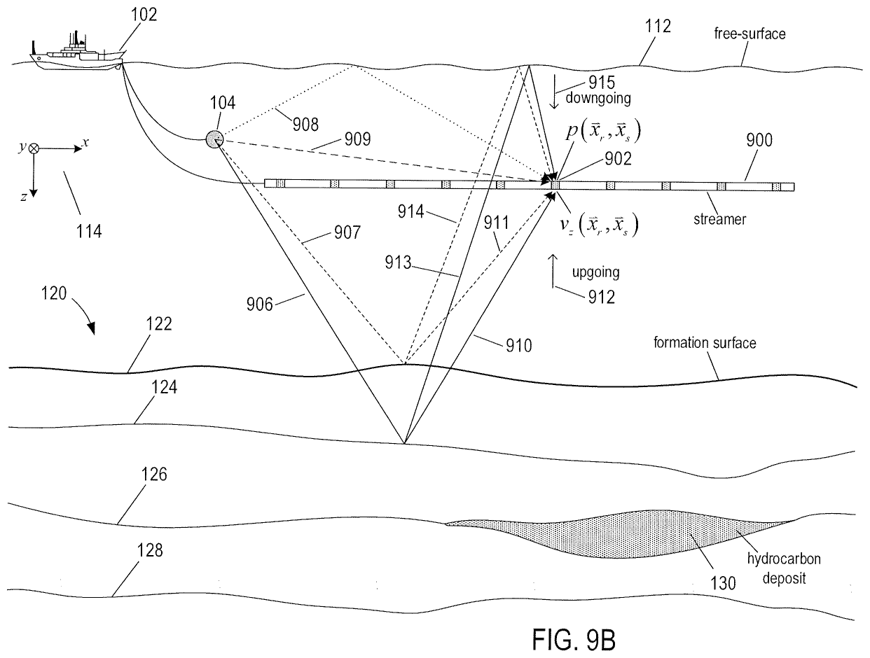

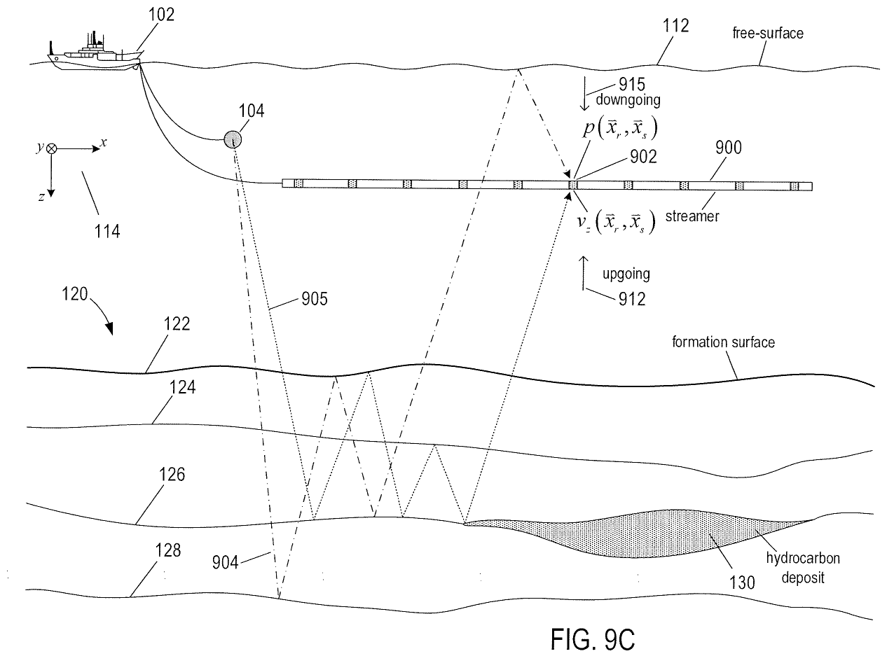

FIGS. 9A-9C show example ray paths of different ways acoustic energy emitted from the vibrational source 104 reverberates between the free surface 112 and reflectors with the subterranean formation 120 before reaching the receiver 902. For the sake of simplicity, FIGS. 9A-9C illustrate only a few of many possible ray paths acoustic energy of an acoustic signal created by the vibrational source 104 may travel before reaching the receiver 902. In FIG. 9A, directional arrows 904-909 represent ray paths of different portions of the acoustic signal generated by the vibrational source 104. For example, ray paths 904-907 represent portions of the acoustic signal that penetrate to different interfaces of the subterranean formation 102 and ray path 908 represents a portion of the acoustic signal that reaches the free surface 112. Ray path 909 represents the source signature, which is a portion of the acoustic signal that travels directly to the receiver 902. In FIG. 9B, ray path 908 is extended to present a downward reflection from the free surface 112 (i.e., source ghost). Ray paths 910 and 911 represent reflections from the interface 124 and the formation surface 122 that travel directly to the receiver 902, which are called “upgoing primary reflections” or “primaries,” as indicated by upgoing directional arrow 912. Ray paths 913 and 914 represent reflections from the interface 124 and the formation surface 122 followed by downward reflections from the free surface 112 before traveling directly to the receiver 902, which are called “downgoing reflections” as indicated by directional arrow 915. In FIG. 9C, ray paths 904 and 905 are extended to represent examples of multiple reflections between interfaces within the subterranean formation 120 and the free surface 112. Extended ray path 904 represents a downgoing free-surface multiple. Extended ray path 905 represents an upgoing multiple. In FIGS. 9B-9C, wavefields that are reflected downward from the free surface 112 before reaching the receivers, as represented by ray paths 913, 914, and 904, are examples of “downgoing wavefields” that may also be called “ghost wavefields.” In FIGS. 9B-9C, wavefields that are reflected upward from the subterranean formation 120, before reaching the receivers, as represented by ray paths 910, 911, and 905, are examples of “upgoing wavefields.” Seismic data may also include acoustic energy that propagated along interfaces as head waves (not shown) before being reflected upward to the surface 122 and acoustic energy that propagated into layers with velocity gradients that increase with depth due to compression, creating diving waves (not shown) that are gradually turned upward to the surface 122.

Each trace records the source signature, source ghost, primaries, and various types of free surface and subsurface multiples. For example, pressure wavefield p( [symbol] ᵣ, [symbol] ₛ, t) generated at the receiver 902 records hydrostatic pressure changes due to the source signature, source ghost, primaries, and multiples. The vertical velocity wavefield v_{z}( [symbol] ᵣ, [symbol] ₛ, t), also generated at the receiver 902, records the particle velocity changes due to the direct source wavefield, source ghost, primaries, and multiples. The pressure wavefield p( [symbol] ᵣ, [symbol] ₛ, t) and the vertical velocity wavefield v_{z}) [symbol] ᵣ, [symbol] ₛ, t) record both upgoing and downgoing pressure and vertical velocity wavefields, respectively, that reach the receiver 902.

Seismic data may be continuously recorded while a moving vibrational source is towed by a survey vessel along a sail line. The moving vibrational source emits a series of sweeps that form a continuous source wavefield. The source wavefield interacts with the subterranean formation producing a reflected wavefield that is continuously emitted from the subterranean formation and recorded as continuously recorded seismic data by receivers of streamers that are towed behind the source or located on the water bottom.

In the following discussion, the terms “continuously recorded” and “recording continuously” indicate that receivers are actively recording seismic data while a series of sweeps are emitted from the one or more marine vibrators, which is significantly longer than the time period in which seismic data is recorded in a shot record of a conventional marine survey. Seismic data is typically not recorded while the survey vessel is turning or during equipment downtime.

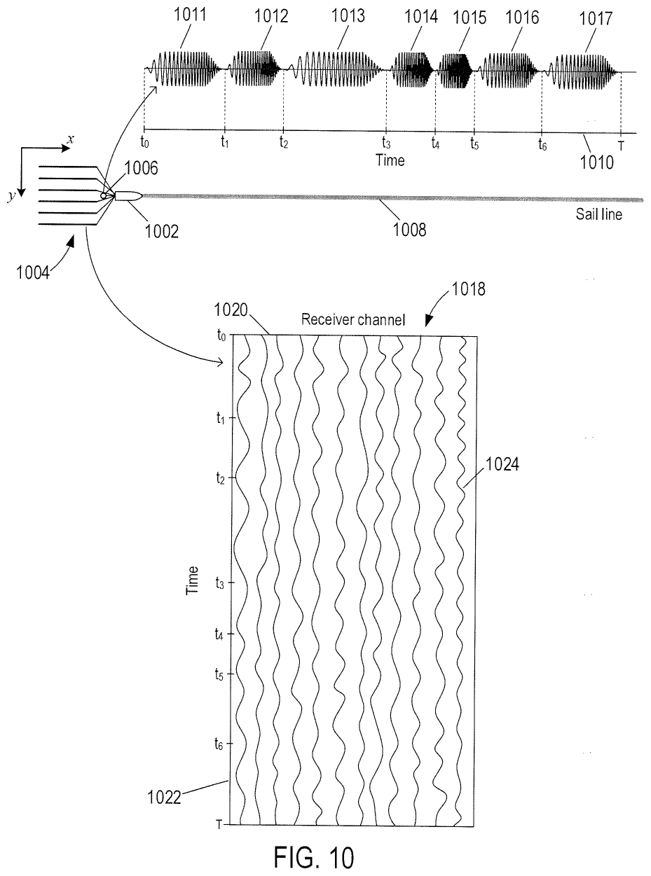

FIG. 10 shows an example of continuously recording seismic data while a survey vessel travels along a sail line and emits from a vibrational source. A survey vessel 1002 tows six streamers 1004 and a vibrational source 1006 along a sail line 1008. FIG. 10 includes a time axis 1010 with times t₀, t₁, t₂, t₃, t₄, t₅ and t₆ that represent start times of sweeps 1011-1017 emitted from the vibrational source 1006 with randomized phases, randomized sweep durations, and without time delays as the survey vessel travels the sail line 1008, as described above with reference to FIGS. 6A-6B. The sweeps emitted from the vibrational source 1006 produce a continuous source wavefield. In other implementations, a continuous source wavefield may be created by emitting overlapping sweeps with randomized phases and randomized sweep durations as described above with reference to FIGS. 7A-7D. Time t₀ is a point in time when continuous recording of seismic data begins and a first sweep 1011 is emitted from the vibrational source 1006. Time T is the point in time when recording along the sail line 1008 stops. FIG. 10 also shows a gather 1018 of a continuously recorded pressure or particle motion wavefield generated by pressure or particle motion sensors of one of the streamers while the survey vessel 1002 travels the sail line 1008. The gather 1018 includes a receiver (i.e., channel) axis 1020 and a time axis 1022 that corresponds to the time axis 1010 and includes the times t₀, t₁, t₂, t₃, t₄, t₅, and T. Wiggle line 1024 represents a trace of continuously recorded seismic data generated by the same pressure or particle motion sensor as the survey vessel 1002 travels the length of the sail line 1008.

In practice, any number of the traces forming a gather of continuously recorded seismic data may include breaks or blank places where no seismic data is recorded due to equipment stoppage, breakdown, or malfunction. For example, a gather of continuously recorded seismic data may have any number of traces with complete, uninterrupted time samples, while other traces in the same gather may have breaks or blank places due to receiver perturbations and/or interruptions in data transmission from receivers to a data-storage device.

Sail lines are not restricted to straight, linear lines as shown in FIG. 10. Sail lines may be curved, circular or any other suitable non-linear path. In other words, receiver locations may vary in both the x- and y-coordinate locations as a survey vessel travels a sail line. For example, in coil shooting surveys, a survey vessel travels in a series of overlapping. near-continuously linked circular, or coiled, sail lines. The circular geometry of the vessel tracks acquires a wide range of offset seismic data across various azimuths to survey a subterranean formation in many different directions. Weather conditions and changing currents may also cause a survey vessel to deviate from a linear path.

### Deconvolving a Total Source Wavefield of a Marine Vibrator from an Upgoing Pressure Wavefield

The continuously recorded pressure and vertical velocity wavefield data are corrected for associated analogue sensor responses and noise attenuation. For example, the pressure wavefield data may be corrected for a resistor-capacitance response of the corresponding pressure sensors. The vertical velocity wavefield data may be corrected for responses related to a response frequency of the particle motion sensors. In the following discussion, the pressure wavefield data and vertical velocity wavefield data simply referred to as the pressure wavefield and vertical velocity wavefield.

Following pre-conditioning, the pressure wavefield p( [symbol] ᵣ, [symbol] ₛ, t) and vertical velocity wavefield vₓ( [symbol] ᵣ, [symbol] ₛ, t) are corrected for receiver motion by associating each time sampled amplitude with the location where the time sampled amplitude was measured. Locations where the time sampled amplitudes of tile continuously recorded pressure wavefield p( [symbol] ᵣ, [symbol] ₛ, t) and continuously recorded vertical velocity wavefield vₓ( [symbol] ᵣ, [symbol] ₛ, t) are called stationary-receiver locations. The upgoing pressure wavefield is computed from the continuously recorded pressure and vertical velocity wavefields in the frequency-wavenumber domain as follows:

$${P}_{up} ( ω , {k}_{xr} , {k}_{y r} ) = \frac{1}{2} {\sum }_{{x}_{r}} {\sum }_{{y}_{r}} {\sum }_{t} [ p ( {x}_{r} ( t ) , {y}_{r} ( t ) , t ) - \frac{ρω}{{k}_{zr}} {v}_{z} ( {x}_{r} ( t ) , {y}_{r} ( t ) , t ) ] {e}^{- i ( ω t + {k}_{xr} {x}_{r} ( t ) + {k}_{y r} {y}_{r} ( t ) )} \qquad ( 5 )$$

where
i=\sqrt{−1};
kₓᵣ is a horizontal wavenumber in theinline direction at a receiver;
k_{yr} is a horizontal wavenumber in the crossline direction at the receiver:
ω is angular frequency;
ρ is the density of the body of water;

$${k}_{zr} = \sqrt{{( \frac{ω}{c} )}^{2} - {k}_{xr}^{2} - {k}_{y r}^{2}}$$

is the vertical wavenumber at the receiver:
c is the speed of sound in water;
p(xᵣ(t), yᵣ(t), t) is the continuously recorded pressure wavefield; and
v(xᵣ(t), yᵣ(t), t) is the continuously recorded vertical velocity.
   Note that the receiver depth and source coordinates are suppressed in Equation (5) for the sake of convenience but the receiver depth and source coordinates are not suppressed in the computations represented in Equations (5) and the computations represented in equations below. The horizontal wavenumber components of the complex-exponential kernel, exp[−i(ωt+kₓᵣxᵣ(t)+k_{yr}yᵣ(t)], in Equation (5) shift the horizontal coordinates (xᵣ(t), yᵣ(t)) of the continuously recorded pressure and vertical velocity wavefields to stationary-receiver locations (xₛₜᵣ, yₛₜᵣ). The upgoing pressure wavefield at stationary-receiver locations may be computed by inverse transforming the upgoing pressure wavefield obtained in Equation (5) from the wavenumber-frequency domain to the space-time domain using an IFFT or an IDFT. Transformation of the upgoing pressure wavefield obtained in Equation (5) to the space-time domain is represented by

P_{up (ω,} kₓᵣ, k_{yr})→pᵤₚ(xₛₜᵣ, yₛₜᵣ, t) (6)

where (xₛₜᵣ, yₛₜᵣ) are coordinates of a stationary-receiver location.

Transformation of the upgoing pressure wavefield computed using Equation (5) to the space-time domain gives the upgoing pressure wavefield at stationary-receiver locations. When the pressure and vertical velocity wavefields are recorded using stationary receivers, such as receivers located on OBCs or OBNs, the receiver coordinate locations in Equation (5) do not change with respect to time.

Each trace of a gather of seismic data at stationary-receiver locations is called a “stationary-receiver trace” that comprises seismic data recorded at a stationary-receiver location. The term “stationary-receiver” as used herein does not imply that a stationary receiver was used to measure the seismic data contained in a stationary-receiver trace. Because the receivers are moving during continuous seismic data recording as explained above, traces of the continuous wavefield may contain seismic data measured at about the same location. The transformation in Equation (5) applies a spatial phase shift to the traces of the continuous seismic data to form stationary-receiver traces that contain the seismic data as if a stationary receiver had instead been placed at the location.

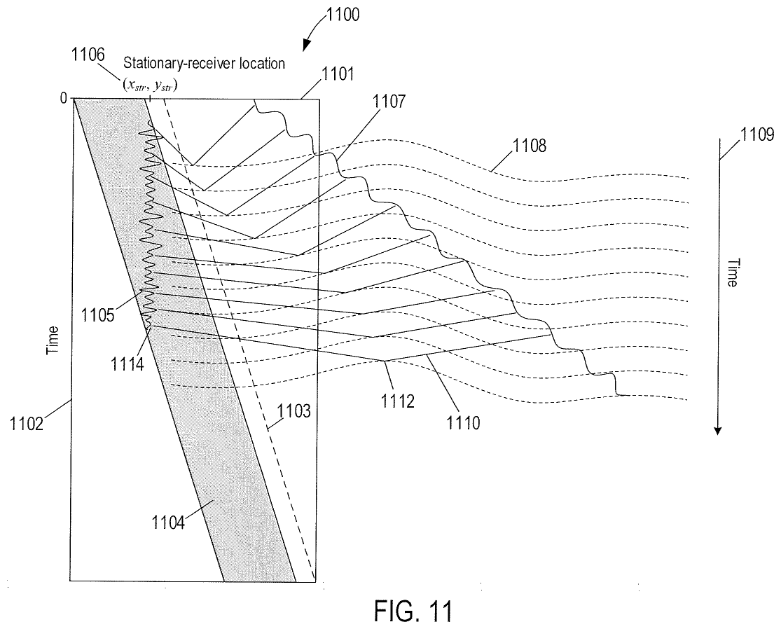

FIG. 11 shows an example matrix of continuous seismic data with traces at stationary-receiver locations 1100. Horizontal axis 1101 represents the spatial extent of a streamer length and length of the sail line. Vertical axis 1102 represents time. Dashed line 1103 represents the location of the source in front of the streamer as a function of time. The seismic data is confined to a diagonal strip represented by shaded region 1104. The seismic data comprises stationary-receiver traces at stationary-receiver-locations. Unshaded portions of the matrix 1100 do not contain seismic data. The stationary-receiver trace 1105 contains the seismic data, such as pressure data, vertical velocity data, or upgoing pressure data, that would have been measured by a stationary pressure or particle motion sensor placed at the stationary-receiver location (xₛₜᵣ, yₛₜᵣ) 1106. Angled curve 1107 represents a sweep emitted from the vibrational source as a function of time with different offsets relative to the receive location. Dashed curves, such as dashed curve 1108, represent an interface between layers of a subterranean formation with passage of time as represented by time axis 1109. Bent lines relate portions of the sweep 1107 that reflect from points on the interface and correspond to a wavelet in the stationary-receiver trace. For example, bent curve 1110 represents a portion of the source signal 1107 that is reflected from interface 1108 at a point 1112 and is recorded in the stationary-receiver trace 1105 as a wavelet 1114.

Each upgoing pressure wavefield trace at a stationary-receiver location is associated with acoustic signals received from any direction and emitted at any angle from the vibrational source. In the space-frequency domain, the upgoing pressure wavefield at each stationary-receiver location is given by:

$${P}_{up} ( ω ) = {\sum }_{{k}_{xs}} {\sum }_{{k}_{ys}} {S}_{tot} ( ω , {k}_{xs} , {k}_{ys} ) G ( ω , {k}_{xs} , {k}_{ys} ) \qquad ( 7 )$$

where
kₓₛ is the source wavenumber in the inline direction;
k_{ys} is the source wavenumber in the crossline direction;
Sₜₒₜ(ω, kₓₛ, k_{ys}) is the total source wavefield emitted from the source; and
G(ω, kₓₛ, k_{ys}) is the earth response to the total source wavefield.

The summations in Equation (7) are over the horizontal source wavenumbers. Equation (7) represents spreading of the source wavefield over all emission angles from the source. The upgoing pressure wavefield Pᵤₚ(ω)=Pᵤₚ(ω, xₛₜᵣ=0, yₛₜᵣ=0) is used for each stationary-receiver location. The total source wavefield emitted from the vibrational source in Equation (7) may be represented by

$${S}_{tot} ( ω , {k}_{xs} , {k}_{ys} ) = {\sum }_{{x}_{sn}} {\sum }_{{y}_{sn}} {\sum }_{t} {s}_{n} ( t , {\vec{x}}_{sn} ( t ) ) [ {e}^{- {ik}_{zs} {z}_{sn ( t )}} - {Re}^{{ik}_{zs} {z}_{sn} ( t )} ] {e}^{- i ( ω t + {k}_{xs} {x}_{sn} ( t ) + {k}_{ys} {y}_{sn} ( t ) )} \qquad ( 8 )$$

where
[e^{-ik}^{_{zs}}^{z}^{ₛₙ}^{(t)}−Re^{ik}^{_{zs}}^{z}^{ₛₙ}^{(t)}] is a ghost function that re-datums the source wavefield to the free surface;

$${k}_{zs} = \sqrt{{( \frac{ω}{c} )}^{2} - {k}_{xs}^{2} - {k}_{ys}^{2}} ;$$

R is the reflectivity of the free surface; and
sₙ(t, [symbol] ₛₙ(t)) is the sweep emitted by a marine vibrator at the location (xₛₙ(t), yₛₙ(t), zₛₙ(t)) and recorded by a collocated pressure sensor (See FIG. 2).
   The total source wavefield, Sₜₒₜ(ω, kₓₛ, k_{ys}), represents the source wavefield contribution to the upgoing pressure wavefield Pᵤₚ(ω) at the stationary-receiver location.

The earth response, G (ω, kₓₛ, k_{ys}), is obtained by deconvolving the total source wavefield, Sₜₒₜ(ω, kₓₛ, k_{ys}), from the upgoing pressure wavefield at stationary-receiver locations, Pᵤₚ(ω)). The emission angle of sweeps emitted from the vibrational source is related to the frequency of the emitted sweeps and the vertical wavenumber of the source by

$$cos {θ}_{s} = c \frac{{k}_{z s}}{ω} \qquad ( 9 )$$

where θₛ is the emission angle of an acoustic signal from the source.

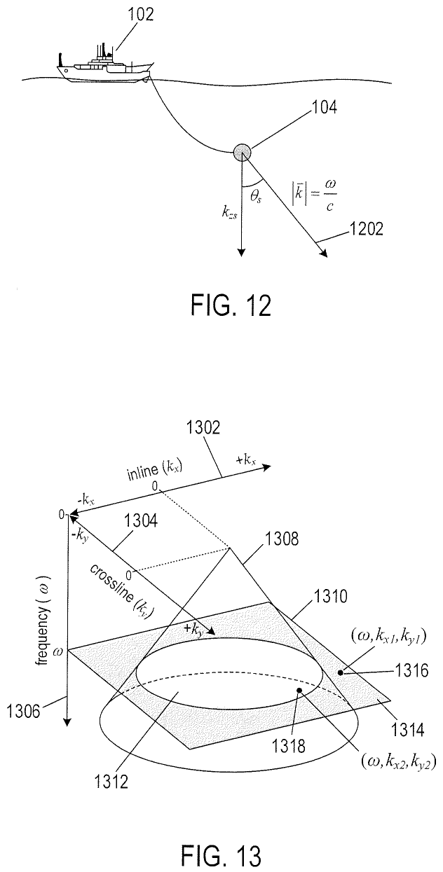

FIG. 12 shows a relationship between an emission angle, θₛ, and a propagation direction 1202 of a sweep emitted from the vibrational source 104. The emission angle cannot be gleaned from a trace of upgoing pressure data at a stationary-receiver location because sweeps emitted from the vibrational source reach the stationary-receive location with different angles. In order to determine the emission angles that are in a trace of upgoing pressure data at a stationary-receiver location, an initial deconvolution is performed by spreading the sweeps across the emission angles. This initial source deconvolution can be expressed as

$$\tilde{G} ( ω , {k}_{x s} , {k}_{y s} ) = w ( ω ) {P}_{up} ( ω ) \frac{{\overline{S}}_{tot} ( ω , {k}_{xs} , {k}_{ys} )}{{\vert {S}_{tot} ( ω , {k}_{xs} , {k}_{ys} ) \vert}^{2} + ɛ} \qquad ( 10 )$$

where
Pᵤₚ(ω)) is the upgoing pressure data in Equation (7);
w(ω) is a user-defined output wavelet; and
\tilde{G}(ω, kₓₛ, k_{ys}) is the estimated earth response of a common receiver gather.

The total source wavefield is deconvolved from each trace of the upgoing pressure wavefield at stationary-receiver locations, taking all possible emission angles into consideration across horizontal wavenumbers associated with the total source wavefield. Because the total source wavefield is spread across all possible source emission angles, the correct angles of emission are included in the deconvolution process. The total source wavefield may be iteratively deconvolved from each trace of the upgoing pressure data using the following iterative process.

When determining the source wavefield to be deconvolved from a received wavefield in a given receiver location, the horizontal wavenumber, kₓₛ, along the vibrational source axis covers all positions in a sail line that may contribute to the receiver location where sweeps have been emitted. The maximum horizontal wavenumber, kₓₛ, is defined by the spacing between the positions where sweeps have been emitted. If the marine vibrators emit sweeps while moving, the maximum horizontal wavenumber may be chosen during processing. In other words, the locations of a bandlimited sweep output from the source deconvolution step can be anywhere along the vibrational source trajectory. If the vibrational source emits sweeps at discrete positions along the line, the spacing between the bandlimited locations of the source output from source deconvolution is limited by the spacing between the locations where the vibrational source emits sweeps. The temporal resolution of the common receiver gathers is limited by the temporal resolution on the receiver side and the bandwidth of the sweeps emitted from the vibrational source. In addition, the temporal resolution is limited by the spatial sampling of the receiver gathers and cannot be determined. As a result, the temporal and spatial resolution of the earth responses in the final common receiver gathers obtained below depend on the characteristics of the source wavefield and on the receiver system.

The inline and crossline locations, (xₛₙ(t), yₛₙ(t)), of the moving vibrational source are constantly changing and the depth zₛₙ(t) of the vibrational source may be changing due to sea surface waves. However, as long as the actual emitted sweeps and the location [symbol] ₛₙ(t) are known as a function of time and used in Equation (8), the earth response may be iteratively obtained as described below.

Let j denote an iteration index such that a superscript “(j)” in the following equations denotes iterative steps 1, 2, 3, . . . . For each trace of the upgoing pressure wavefield at stationary-receiver locations, begin by setting an initial upgoing pressure wavefield equal to the upgoing pressure wavefield obtained from wavefield separation represented by Equation (7):

Pᵤₚ⁽¹⁾(ω)=Pᵤₚ(ω) (11a)

and by setting an initial coherent signal equal to zero:

E(ω, kₓₛ, k_{ys})=0 (11b)

The earth response may be iteratively computed for j=1, 2, 3, . . . using Equation (7) as follows:

$${\overline{G}}^{( j )} ( ω , {k}_{xs} , {k}_{ys} ) = w ( ω ) {P}_{u p}^{( j )} ( ω ) \frac{{\overline{S}}_{tot} ( ω , {k}_{xs} , {k}_{ys} )}{{\vert {S}_{tot} ( ω , {k}_{xs} , {k}_{ys} ) \vert}^{2} + ɛ} \qquad ( 12 )$$

After the earth response, \tilde{G}^{(j)}(ω, kₓₛ, k_{ys}), is calculated for each iteration, the coherent signal. E^{(j)}(ω, kₓₛ, k_{ys}), may be extracted from the earth response, \tilde{G}^{(j)}(ω, kₓₛ, k_{ys}), using one or more of the following techniques. In one implementation, coherent signals located along hyperbolic trajectories within a specified velocity range are extracted. Hyperbolic reflection events of the hyperbolic trajectories in the earth response, \tilde{G}^{(j)}(ω, kₓₛ, k_{ys}), may be identified using automated semblance analysis. The coherent signal, E^{(j)}(ω, kₓₛ, k_{ys}), is extracted by filtering out signals that do not follow the identified hyperbolic reflection events. In another implementation, the coherent signal E^{(j)}(ω, kₓₛ, k_{ys}), corresponds to the energetic events extracted from the earth response in time-space and after plane wave decomposition. The coherent signal, E^{(j)}(ω, kₓₛ, k_{ys}), is located within a signal cone of the earth response, \tilde{G}^{(j)}(ω, kₓₛ, k_{ys}), and is obtained by muting setting to zero) portions of the earth response that are located outside the signal cone. In another implementation, the coherent signal, E^{(j)}(ω, kₓₛ, k_{ys}), is obtained by identifying and muting incoherent signals in the earth response. \tilde{G}^{(j)}(ω, kₓₛ, k_{ys}), leaving the coherent signal E^{(j)}(ω, kₓₛ, k_{ys}). The extracted coherent signal, E^{(j)}(ω, kₓₛ, k_{ys}), for each iteration contains angle information.

After each extraction of the coherent signal E^{(j)}(ω, kₓₛ, k_{ys}), from the earth response \tilde{G}^{(j)}(ω, kₓₛ, k_{ys}), the coherent signal, E^{(j)}(ω, kₓₛ, k_{ys}), is checked to determine whether the coherent signal contains sufficient coherent signal information. The coherent signal, E^{(j)}(ω, kₓₛ, k_{ys}), may be transformed from the frequency-wavenumber domain to the) space-time domain to obtain a coherent signal trace at a stationary-receiver location, e^{(j)}(xₛₜᵣ, yₛₜᵣ, t). The iterative process stops, when the following condition is satisfied

$$\vert {E}^{( j )} ( ω , {k}_{xs} , {k}_{ys} ) \vert = {\sum }_{l = 0}^{L - 1} {\vert {e}^{( j )} ( {x}_{str} , {y}_{str} , {t}_{l} ) \vert}^{2} < T \qquad ( 13 )$$

where
e^{(j)}(xₛₜᵣ, yₛₜᵣ, tₗ) is an amplitude at time sample tₗ of the coherent signal trace e^{(j)}(xₛₜᵣ, yₛₜᵣ, t); and
T is a user-defined coherent-signal threshold.
   Otherwise, when the condition represented in Equation (13) is not satisfied, the coherent signal, E^{(j)}(ω, kₓₛ, k_{ys}), still contains coherent signal information. A contribution of coherent signals to the upgoing pressure wavefield at the stationary-receiver location is update as follows:

E^{(j)}(ω, kₓₛ, k_{ys})=E(ω, kₓₛ, k_{ys})+E^{(j)}(ω, kₓₛ, k_{ys}) (14)

The coherent signal contribution to the upgoing pressure wavefield at the stationary-receiver location is computed by

$${B}_{up} ( ω , {x}_{str} , {y}_{str} ) = {\sum }_{{k}_{xs}} {\sum }_{{k}_{ys}} {S}_{tot} ( ω , {k}_{xs} , {k}_{ys} ) E ( ω , {k}_{xs} , {k}_{ys} ) . \qquad ( 15 )$$

The upgoing pressure wavefield at the stationary-receiver location is updated for a next iteration by subtracting the coherent signal contribution from the upgoing pressure wavefield at the stationary-receiver location in the space-frequency domain as follows:

Pᵤₚ^{(j+1)}(ω, xₛₜᵣ, yₛₜᵣ)=Pᵤₚ^{(j)}(ω, xₛₜᵣ, yₛₜᵣ)−Bᵤₚ(ω, xₛₜᵣ, yₛₜᵣ) (16)

The updated upgoing pressure wavefield at the stationary-receiver location, Pᵤₚ^{(j+1)}(ω, xₛₜᵣ, yₛₜᵣ), is transformed from the space-frequency domain to the wavenumber-frequency domain to obtain Pᵤₚ^{(j+1)}(ω). An updated earth response, \tilde{G}^{(j+1)}(ω, kₓₛ, k_{ys}), is computed using the updated upgoing pressure wavefield Pᵤₚ^{(j+1)}(ω) in Equation (11a) and the process described above is repeated.

When the iterative process stops because the condition in Equation (13) is satisfied, the coherent signals, E^{(j)}(ω, kₓₛ, k_{ys}), can no longer be extracted from the earth response, \tilde{G}^{(j)(ω, k}ₓₛ, k_{ys}). Let \tilde{G}^{(final)}(ω, kₓₛ, k_{ys}) represent a final earth response obtained from Equation (12) with extracted coherent signals E^{(j)}(ω, kₓₛ, k_{ys}) that do not satisfy the condition in Equation (13). The contribution of the coherent signals, E(ω, kₓₛ, k_{ys}), are added to the final earth response to give:

\tilde{G}(ω, kₓₛ, k_{ys})=\tilde{G}^{(final)}(ω, kₓₛ, k_{ys})+E(ω, kₓₛ, k_{ys}) (17)

The earth response, \tilde{G}(ω, kₓₛ, k_{ys}), may be transformed from the wavenumber-frequency domain to the space-time domain to obtain an earth response trace, \tilde{g}(xₛₜᵣ, yₛₜᵣ, t), at the, stationary receiver location. The iterative process described above with reference to Equations (11a)-(17) is repeated for each trace (i.e., stationary-receiver location) of the stationary receiver gather of the upgoing pressure wavefield pᵤₚ(xₛₜᵣ, yₛₜᵣ, t) to obtain a gather of earth response traces \tilde{g}(xₛₜᵣ, yₛₜᵣ, t) at stationary receiver locations.

Low-frequency noise is effectively removed from the signal component of the gather of earth response traces \tilde{g}(xₛₜᵣ, yₛₜᵣ, t) at stationary receiver locations as follows. The frequency ω of a sound wave, wavenumber k of the sound wave, and speed c of the sound wave propagating in water are related by ω=kc. Because a signal component of the earth response trace propagates with a phase velocity greater than or equal to c, the signal component lies within a signal region, or cone, defined by frequency-to-wavenumber ratios that are greater than or equal to c (i.e., ω/k>c). The signal cone contains signal components of the earth response that propagate at speeds greater than or equal to c. The signal cone may also contain noise that propagates at speeds greater than or equal to c. The signal cone may be determined by transforming earth response traces \tilde{g}(xₛₜᵣ, yₛₜᵣ, t) at stationary receiver locations from the space-time domain to the wavenumber-frequency domain.

FIG. 13 shows an example signal cone for an earth response trace, \tilde{G}(ω, kₓₛ, k_{ys}), in the wavenumber-frequency domain. Axis 1302 represents inline wavenumbers (i.e., kₓ) and axis 1304 represents crossline wavenumbers (i.e., k_{y}). Axis 1306 represents frequencies (ω). A signal cone 1308 is a region in the wavenumber-frequency domain with a cone boundary for frequencies and horizontal wavenumbers given by:

$$c = \frac{ω}{\sqrt{{k}_{x}^{2} + {k}_{y}^{2}}} \qquad ( 18 )$$

Horizontal plane 1310 is located at a frequency, ω, and parallel to the inline-crossline coordinate plane. The horizontal plane 1310 includes a light shaded circle 1312 that corresponds to points located inside the signal cone 1308 with the same frequency ω, and a dark shaded region 1314 that corresponds to points located outside the signal cone 1308 with the same frequency ω. Points located in the horizontal plane 1310 and outside the signal cone in the dark shade region 1314, such as point (ω, kₓ₁, k_{y1}) 1316, have speeds that are less than the speed of sound in water c. Points located in the horizontal plane 1310 and inside the light shade circle 1312, such as point (ω, kₓ₂, k_{y2}) 1318, have speeds that are greater than the speed of sound in water c. Points located inside the signal cone 1308 correspond to the signal component of the earth response trace \tilde{g}(xₛₜᵣ, yₛₜᵣ, t). By contrast, points located outside the signal cone 1308 correspond to low-frequency noise that propagates at lower speeds than the speed of sound in water c. Amplitudes at points located outside the signal cone may be muted and the operations represented by Equations (11a)-(17) repeated for each trace until the low-frequency noise is below an acceptable level.

The earth response traces obtained after source wavefield deconvolution described above may be sorted to form earth response gathers in the common receive domain. By emitting sweeps with randomized phases and/or randomized sweep durations from a moving vibrational source as described above, the earth response gathers have been produced with reduced spatial aliasing and reduced crosstalk noise. The earth response gathers may be used to generate an image of the subterranean formation using time or depth migration.

### Seismic Imaging

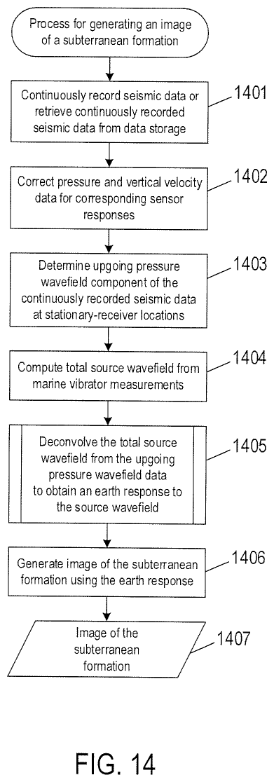

FIG. 14 is a flow diagram of a process for generating an image of a subterranean formation from continuously recorded seismic data obtained in a marine seismic survey. Each block represents computer implemented machine-readable instructions stored in one or more data-storage devices and executed using one or more processors of a computer system. It should be noted that the series of blocks represented in FIG. 14 is not an exhaustive list of the computational operations executed to compute an image of a subterranean formation from continuously recorded seismic data. Processing may include additional computational operations or certain computational operations may be omitted or placed in a different ordering, depending on, for example, how the seismic data is collected, conditions under which the seismic data is collected, and depth of the body of water above the subterranean formation.

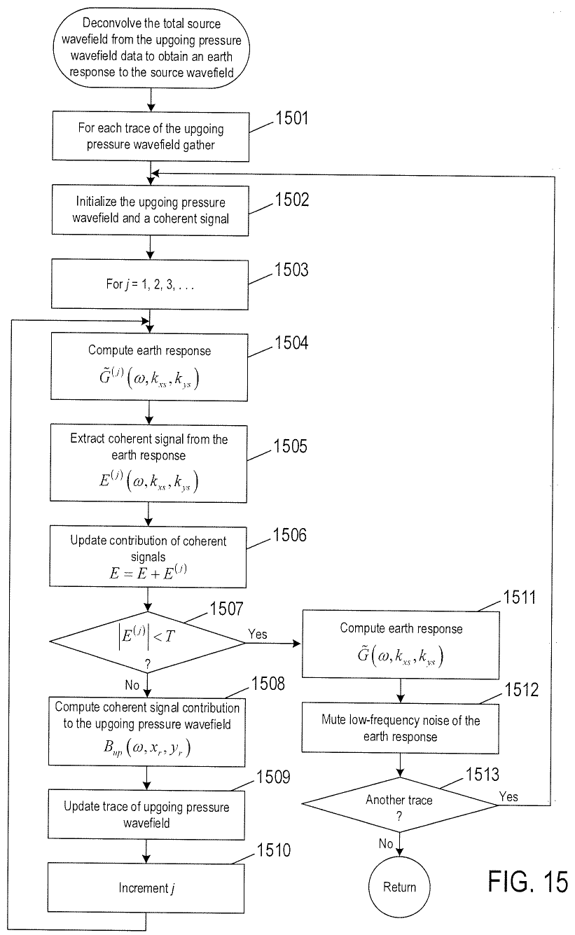

In FIG. 14, block 1401 represents receiving continuously recorded seismic data from a survey as described above or retrieved from data storage. The continuously recorded seismic data may be continuously recorded pressure and vertical velocity data recorded using receivers configured with collocated pressure and particle motion sensors. In block 1402, the continuously recorded pressure and vertical velocity data are corrected for pressure and particle velocity sensor responses. In block 1403, the upgoing pressure wavefield component of the continuously recorded seismic data at stationary-receiver location is determined as described above with reference to Equation (5). In block 1404, the total source wavefield is computed from sweeps emitted from the vibrational source and measured by collocated pressure sensors as described above with reference to Equation (8). In block 1405, an “deconvolve the total source wavefield from the upgoing pressure wavefield data to obtain an earth response to the source wavefield” procedure is performed. An example implementation of the “deconvolve the total source wavefield from the trace of upgoing pressure wavefield data to obtain an earth response to the source wavefield” procedure is described below with reference to FIG. 15. The earth response to the source wavefield output from the procedure performed in block 1405 is an earth response gather. In block 1406, time or depth migration is used to generate an image of the subterranean formation 1407 using the earth response gather at the stationary-receiver locations and a velocity of the subterranean formation.

FIG. 15 is a flow diagram illustrating an example implementation of the “deconvolve the total source wavefield from the upgoing pressure wavefield data to obtain an earth response to the source wavefield” procedure performed in step 1405 of FIG. 14. A loop beginning with block 1501 repeats the computational operations represented by blocks 1502-1512 for each trace of an upgoing pressure wavefield gather. In block 1502, an initial upgoing pressure wavefield is initialized using the upgoing pressure wavefield obtained in block 1403 of FIG. 14. A loop beginning with block 1502 iterates the computational operations represented by blocks 1504-1512 to obtain the earth response with low-frequency noise attenuated. In block 1504, the earth response is computed as described above with reference to Equation (12). In block 1505, a coherent signal is extracted from the earth response. For example, the coherent signal may be extracted by filtering out signals that do not follow identified hyperbolic reflection events of the earth response, by muting portions of the earth response that are located outside the signal cone of the earth response, or by identifying and muting incoherent signals in the earth response. In block 1506, a contribution of coherent signals to the upgoing pressure wavefield at the stationary-receiver location is computed as described above with reference to Equation (14). In decision block 1507, when the contribution to the coherent signal is greater than a coherent-signal threshold as described above with reference to the condition in Equation (13), control flows to block 1511. In block 1508, a coherent signal contribution to the upgoing pressure wavefield is computed as described above with reference to Equation (14). In block 1509, the trace of upgoing pressure wavefield data is updated, as described above with reference to Equations (15) and (16). In block 1510, the iteration index j is incremented. In block 1511, the earth response is computed based on the contribution of coherent signals obtained in block 1506. In block 1512, low-frequency noise is attenuated in the earth response by muting amplitudes located outside the frequency cone of the earth response. In decision block 1513, the operations represented by blocks 1502-1512 are repeated for another trace of the upgoing pressure wavefield gather. In other implementation, the operations represented blocks 1503-1512 may be repeated for a fixed number of iterations or until low-frequency noise located outside the signal cone of the earth response is falls below an acceptable limit.

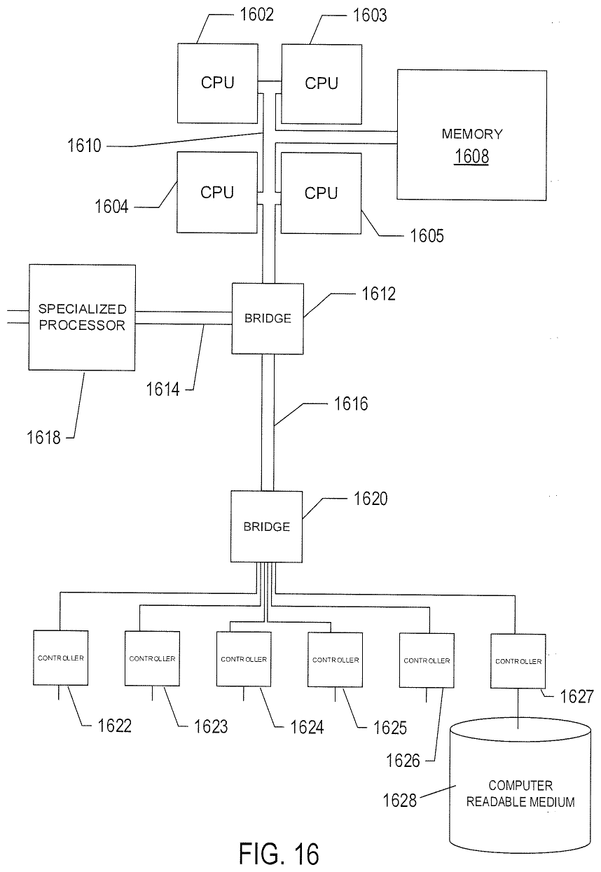

FIG. 16 shows an example computer system that may be used to execute an efficient process for generating an image of subterranean formation according to methods described herein, and therefore represents a geophysical-analysis data-processing system. The internal components of many small, mid-sized, and large computer systems as well as specialized processor-based storage systems can be described with respect to this generalized architecture, although each system may feature many additional components, subsystems, and similar, parallel systems with architectures similar to this generalized architecture. The computer system contains one or multiple central processing units (“CPUs”) 1602-1605, one or more electronic memories 1608 interconnected with the CPUs by a CPU/memory-subsystem bus 1610 or multiple busses, a first bridge 1612 that interconnects the CPU/memory-subsystem bus 1610 with additional busses 1614 and 1616, or other types of high-speed interconnection media, including multiple, high-speed serial interconnects. The busses or serial interconnections, in turn, connect the CPUs and memory with specialized processors, such as a graphics processor 1618, and with one or more additional bridges 1620, which are interconnected with high-speed serial links or with multiple controllers 1622-1627, such as controller 1627, that provide access to various different types of computer-readable media, such as computer-readable medium 1628, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 1628 is a data-storage device, which may include, for example, electronic memory, optical or magnetic disk drive, a magnetic tape drive. USB drive, flash memory and any other such data-storage device or devices. The computer-readable medium 1628 can be used to store machine-readable instructions that encode the computational methods described above. The computer-readable medium 1628 or similar devices can also be used to store geophysical data that results from application of the above methods to recorded seismic signals.

The processes and systems disclosed herein may be used to manufacture a geophysical data product indicative of certain properties of a subterranean formation. A geophysical data product may be manufactured by using the processes and systems described herein to generate geophysical data and storing the geophysical data in a computer-readable medium 1628. The geophysical data may be pressure data, vertical velocity data, upgoing and downgoing wavefields, deblended wavefield with attenuated source ghost and source signature, and any image of a subterranean formation computed using the processes and systems described herein. The geophysical data product may he produced offshore (i.e., by equipment on the survey vessel 102) or onshore (i.e., at a computing facility on land), or both.

### Simulation Results

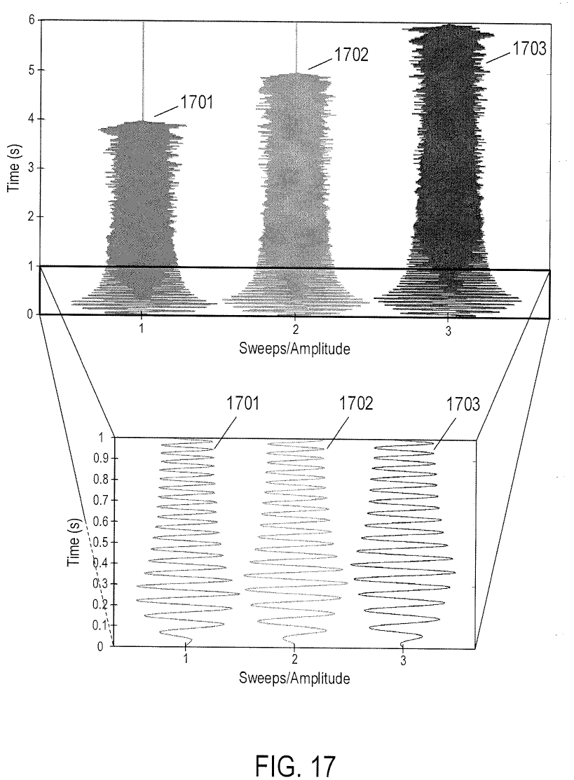

Modeled seismic data was produced from modeled sweeps with randomized phases and randomized sweep durations and compared with modeled seismic data produced from modeled sweeps without randomized phases and randomized sweep durations. FIG. 17 shows plots of three modeled sweep signatures 1701-1703. The modeled sweep signatures exhibit an increase in amplitude between 0 and 1 second. Beyond 1 second the amplitudes vary and taper near the end. The sweep signatures were generated over the same sweep-frequency range of 5-100 Hz with a linear increasing frequency. FIG. 17 includes a magnified of the sweep signatures 1701-1703 over the time interval between 0 and 1 second. Sweep 1701 was generated with no phase. Sweep 1702 was generated with a 90-degree phase. Sweep 1703 was generated with a 180-degree phase. The sweep signatures 1701-1703 were generated with randomized sweep durations between 4 and 6 seconds.

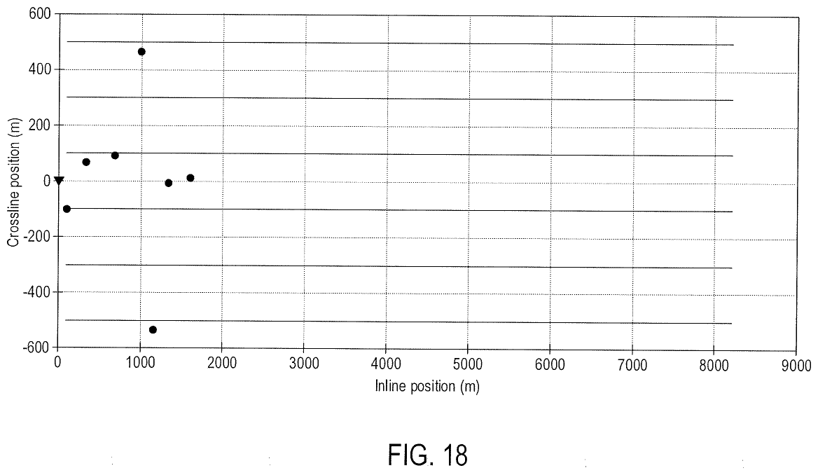

FIG. 18 shows a plot of a seismic data acquisition layout. Horizontal lines present six source line positions separated by 200 m in the crossline direction. The triangle is the location of a receiver at the origin. The solid dots are the inline and crossline coordinate locations of point diffractors inside an earth model.

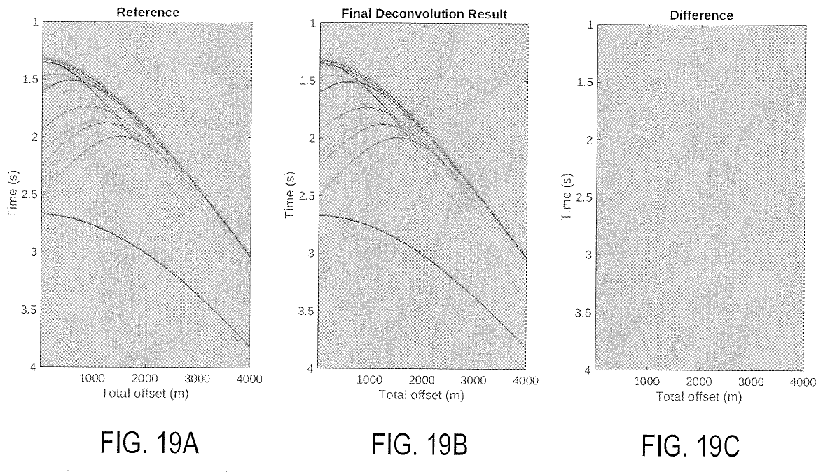

FIG. 19A shows a reflectivity gather used for simulation of marine seismic data acquired in a marine survey with marine vibrators. In other words, the gather in FIG. 19A represents a desired output from deconvolving a source wavefield from an upgoing pressure wavefield in stationary receiver locations. FIG. 19B shows a final gather of seismic data after six iterations of source deconvolution as described above and shown in FIG. 15. FIG. 19C shows a gather of the difference between the gathers in FIGS. 19A and FIG. 19B. The results in FIGS. 19A-19C were obtaining for a seismic data modeled obtained using linear sweeps with a randomized duration, four, five, and six second sweep durations, a sweep-frequency range of 5-100 Hz, and randomized phase. Three modeled marine vibrators were separated by 1.5 meters in the inline direction. The marine vibrators emitted sweeps in randomized sweep durations with 2.5±0.25 seconds of time delay between end of the one sweep and the start of a next sweep. Part of the difference shown in FIG. 19C reveals similar moveout to the seismic data shown in FIG. 19A and is related to spatial aliasing that results from movement of the marine vibrator and the duration of the sweep. The source deconvolution result shown in FIG. 19B were stopped after six iterations. The deconvolution result of the last residuals was added to the extracted signals that were accumulated via the iterations. Very small errors can be observed in FIG. 19C.

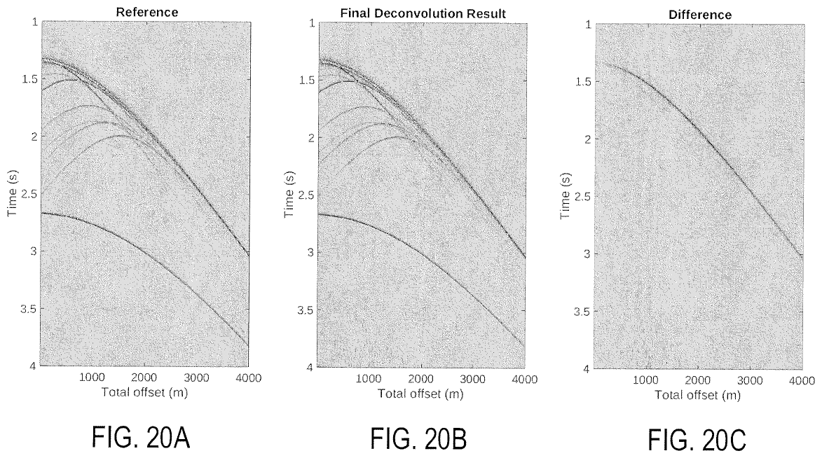

FIG. 20A shows the reflectivity gather shown in FIG. 19A. FIG. 20B shows a final gather of seismic data obtained after four iterations of source deconvolution as described above and shown in FIG. 15. FIG. 20C shows a gather of the difference between the gathers in FIGS. 20A and FIG. 20B. The results in FIGS. 20A-20C were obtaining using aseismic data modeled for linear sweeps with fixed five second sweep durations and randomized phases at the start time of each sweep. The difference gather shown in FIG. 20C reveals noise spikes related to “cross-talk” between sweeps below 3.5 s and aliasing.

The results in FIGS. 19C and 20C reveal that there are fewer residual errors in the results shown in FIG. 19B than in the results shown in FIG. 20B due to less spatial aliasing in the randomized case of FIGS. 19A-19C. As a result, it is possible to recover seismic data beyond the regular Nyquist frequency or wavenumber for sweeps generated using randomized phases and randomized sweep durations.

It is appreciated that the previous description of the disclosed embodiments is provided to enable any person skilled in the art to make or use the present disclosure. Various modifications to the embodiments will be apparent to those skilled in the art, and the generic principles defined herein may be applied to other embodiments without departing from the spirit or scope of the disclosure. Thus, the present disclosure is not intended to be limited strictly to the embodiments shown herein but is to be accorded the widest scope consistent with the principles and novel features disclosed herein.

1. A method for performing a marine survey, the method comprising:
towing a vibrational source in a body of water above a subterranean formation;
emitting sweeps from the vibrational source into the body of water, wherein each sweep is emitted with at least one of a randomized phase and a randomized sweep duration; and
recording wavefields reflected from the subterranean formation in response to the sweeps as seismic data using receivers located in the body of water.

2. The method of claim 1 wherein emitting the sweeps from the vibrational source comprises emitting the sweeps with no time delay between the ending of one sweep and the beginning of a next sweep.

3. The method of claim 1 wherein emitting the sweeps from the vibrational source comprises emitting each sweep to overlap with emission of at least one previously emitted sweep from the vibrational source.

4. The method of claim 1 wherein emitting the sweeps from the vibrational source comprises emitting the sweeps to create a continuous source wavefield.

5. The method of claim 1 wherein emitting the sweeps from the vibrational source comprises emitting the sweeps with a random time delay between the ending of one sweep and the beginning of a next sweep.

6. The method of claim 1 wherein the vibrational source comprises a single marine vibrator.

7. The method of claim 1 wherein the vibrational source comprises two or more marine vibrators.

8. A method for recording seismic data in a marine survey of a subterranean formation, the method comprising:
towing a vibrational source in a body of water above the subterranean formation;
emitting a continuous source wavefield from the vibrational source; and
continuously recording wavefields reflected from the subterranean formation in response to the continuous source wavefield using receiver located in the body of water.

9. The method of claim 8 wherein emitting the continuous source wavefield comprises emitting sweeps from the vibrational source with no time delay between the ending of one sweep and the beginning of a next sweep.

10. The method of claim 8 wherein emitting the continuous source wavefield comprises emitting overlapping sweeps from the vibrational source, each sweep overlapping a previously emitted sweep from the vibrational source.

11. The method of claim 8 wherein the continuous source wavefield comprises emitting a series of sweeps from the vibrational source, w herein each sweep is emitted with at least one of a randomized phase and a randomized sweep duration.

12. The method of claim 8 wherein the vibrational source comprises a single marine vibrator.

13. The method of claim 8 wherein the vibrational source comprises two or more marine vibrators.

14. A method for operating a vibrational source in a marine survey, the method comprising:
generating randomized phase and/or randomized sweeps duration parameters for emitted sweeps from a vibrational source: and
emitting sweeps into a body of water from the vibrational source to create a continuous source wavefield in accordance with the randomized phase and/or randomized sweeps duration parameters.

15. The method of claim 14 wherein emitting the sweeps from the vibrational source comprises emitting the sweeps with no time delay between the ending of one sweep and the beginning of a next sweep.

16. The method of claim 14 wherein emitting the sweeps from the vibrational source comprises emitting each sweep to overlap with at least one previously emitted sweep from the vibrational source.

17. The method of claim 14 wherein emitting the sweeps from the vibrational source comprises emitting each sweep over the same sweep frequency range.

18. The method of claim 14 wherein emitting the sweeps from the vibrational source comprises emitting the sweeps from two or more marine vibrators that form the vibrational source, each marine vibrator emits a sweep over a different sweep frequency range.

19. The method of claim 14 wherein the vibrational source is moving.

20. A method for manufacturing a geophysical data product, the method comprising:
towing a vibrational source in a body of water above a subterranean formation:
emitting sweeps from the vibrational source into the body of water, wherein each sweep is emitted with at least one of a randomized phase and a randomized sweep duration;
recording wavefields reflected from the subterranean formation in response to the sweeps as seismic data using receivers located in the body of water; and
storing the recorded wavefields in a non-transitory computer-readable medium.
